(19) United States
(12) Patent Application Publication
(10) Pub. No.: US 2026/0067052 A1
(43) Pub. Date: Mar. 5, 2026

(54) SYSTEMS AND TECHNIQUES FOR PHASE-BASED MEASUREMENTS IN CARRIER PHASE POSITIONING

(71) Applicant: QUALCOMM Incorporated, San Diego, CA (US)

(72) Inventors: Alexandros MANOLAKOS, Athens (GR); Mukesh KUMAR, Hyderabad (IN); Srinivas YERRAMALLI, San Diego, CA (US)

(21) Appl. No.: 18/718,420

(22) PCT Filed: Dec. 22, 2022
(86) PCT No.: PCT/US2022/082282

§ 371 Date: Jun. 10, 2024

(30) Foreign Application Priority Data
Feb. 2, 2022 (GR) 20220100106

(51) Int. Cl. H04L 5/00; G01S 5/14; H04W 24/10

(52) U.S. Cl. CPC H04L 5/0094; G01S 5/14; H04W 24/10

(57) ABSTRACT

Disclosed are systems, apparatuses, processes, and computer-readable media for wireless communications, such as to measure a location of a user equipment (UE). A process may include transmitting, at the UE (305), a phase measurement capability of the UE to a network entity (310, 315, 320) for determining a position of the UE. The process may further include receiving, at the UE from the network entity, a phase measurement request for reporting phase measurements for one or more subcarriers received by the UE. The phase measurement request is based on the phase measurement capability of the UE. The process may further include transmitting a phase measurement report to the network entity based on the phase measurement request. The phase measurement report includes information associated with a measured phase of at least one subcarrier of the one or more subcarriers.

### CROSS-REFERENCE TO RELATED APPLICATIONS

This application for patent is a 371 of international Patent Application PCT/US2022/082282, filed Dec. 22, 2022, which claims priority to Greek Patent Application 20220100106, filed Feb. 2, 2022, all of which are hereby incorporated by reference in their entirety and for all purposes.

### FIELD

The present disclosure generally relates to carrier phase positioning. For example, aspects of the present disclosure relate to systems and techniques for using subcarriers in a wireless communication system for determining a position of a mobile device.

### BACKGROUND

Wireless communication systems have developed through various generations, including a first-generation analog wireless phone service (1G), a second-generation (2G) digital wireless phone service (including interim 2.5G networks), a third-generation (3G) high speed data, Internet-capable wireless service, and a fourth-generation (4G) service (e.g., Long-Term Evolution (LTE), WiMax). There are presently many different types of wireless communication systems in use, including cellular and personal communications service (PCS) systems. Examples of known cellular systems include the cellular Analog Advanced Mobile Phone System (AMPS), and digital cellular systems based on code division multiple access (CDMA), frequency division multiple access (FDMA), time division multiple access (TDMA), the Global System for Mobile communication (GSM), etc.

A fifth generation (5G) mobile standard calls for higher data transfer speeds, greater numbers of connections, and better coverage, among other improvements. The κG standard (also referred to as “New Radio” or “NR”), according to the Next Generation Mobile Networks Alliance, is designed to provide data rates of several tens of megabits per second to each of tens of thousands of users with, for example, a gigabit connection speeds to tens of users in a common location, such as on an office floor. Several hundreds of thousands of simultaneous connections should be supported in order to support large sensor deployments. Consequently, the spectral efficiency of 5G mobile communications should be significantly enhanced compared to the current 4G/LTE standard. Furthermore, signaling efficiencies should be enhanced and latency should be substantially reduced compared to current standards.

### SUMMARY

Systems and techniques are described herein that provide reference signals for enhanced carrier phase measurements for carrier phase positioning with wireless communication systems. In one illustrative example, a process for wireless communications at a user equipment (UE) is provided. The process includes: transmitting, at the UE, a phase measurement capability of the UE to a network entity for determining a position of the UE; receiving, at the UE from the network entity, a phase measurement request for reporting phase measurements for one or more subcarriers received by the UE, the phase measurement request being based on the phase measurement capability of the UE; transmitting a phase measurement report to the network entity based on the phase measurement request, the phase measurement report including information associated with a measured phase of at least one subcarrier of the one or more subcarriers.

In another example, an apparatus for wireless communications is provided that includes a memory (e.g., configured to store data, such as virtual content data, one or more images, etc.) and one or more processors (e.g., implemented in circuitry) coupled to the memory. The one or more processors are configured to and can: transmit a phase measurement capability of the apparatus to a network entity for determine a position of the apparatus; receive, from the network entity, a phase measurement request for report phase measurements for one or more subcarriers received by the apparatus, the phase measurement request be based on the phase measurement capability of the apparatus; and transmit a phase measurement report to the network entity based on the phase measurement request, the phase measurement report including information associated with a measured phase of at least one subcarrier of the one or more subcarriers.

In another example, a non-transitory computer-readable medium of a user equipment (UE) is provided that has stored thereon instructions that, when executed by one or more processors, cause the one or more processors to: transmit a phase measurement capability of the UE to a network entity for determine a position of the UE; receive, at the UE, from the network entity, a phase measurement request for report phase measurements for one or more subcarriers received by the UE, the phase measurement request be based on the phase measurement capability of the UE; and transmit a phase measurement report to the network entity based on the phase measurement request, the phase measurement report including information associated with a measured phase of at least one subcarrier of the one or more subcarriers.

In another example, an apparatus for wireless communications is provided. The apparatus includes: means for transmitting a phase measurement capability of the apparatus to a network entity for determining a position of the apparatus; means for receiving, from the network entity, a phase measurement request for reporting phase measurements for one or more subcarriers received by the apparatus, the phase measurement request being based on the phase measurement capability of the apparatus; and means for transmitting a phase measurement report to the network entity based on the phase measurement request, the phase measurement report including information associated with a measured phase of at least one subcarrier of the one or more subcarriers.

According to another example, a method is provided for wireless communications at a network entity. The method includes: receiving, at the network entity, a phase measurement capability of a user equipment (UE) for determining a position of the UE; transmitting, to the UE, a phase measurement request for reporting phase measurements for one or more subcarriers received by the UE, the phase measurement request being based on the phase measurement capability of the UE; receiving, at the network entity, a phase measurement report based on the phase measurement request, the phase measurement report including information associated with a measured phase of at least one subcarrier of the one or more subcarriers.

In another example, an apparatus for wireless communications is provided that includes a memory (e.g., configured to store data, such as virtual content data, one or more images, etc.) and one or more processors (e.g., implemented in circuitry) coupled to the memory. The one or more processors are configured to and can: receive a phase measurement capability of a user equipment (UE) for determine a position of the UE; transmit, to the UE, a phase measurement request for report phase measurements for one or more subcarriers received by the UE, the phase measurement request be based on the phase measurement capability of the UE; and receive a phase measurement report based on the phase measurement request, the phase measurement report including information associated with a measured phase of at least one subcarrier of the one or more subcarriers.

In another example, a non-transitory computer-readable medium of a network entity is provided that has stored thereon instructions that, when executed by one or more processors, cause the one or more processors to: receive a phase measurement capability of a user equipment (UE) for determine a position of the UE; transmit, to the UE, a phase measurement request for report phase measurements for one or more subcarriers received by the UE, the phase measurement request be based on the phase measurement capability of the UE; and receive a phase measurement report based on the phase measurement request, the phase measurement report including information associated with a measured phase of at least one subcarrier of the one or more subcarriers.

In another example, an apparatus for wireless communications is provided. The apparatus includes: means for receiving a phase measurement capability of a user equipment (UE) for determining a position of the UE; means for transmitting, to the UE, a phase measurement request for reporting phase measurements for one or more subcarriers received by the UE, the phase measurement request being based on the phase measurement capability of the UE; and means for receiving a phase measurement report based on the phase measurement request, the phase measurement report including information associated with a measured phase of at least one subcarrier of the one or more subcarriers.

In some aspects, the apparatus is, is part of, and/or includes a wearable device, an extended reality device (e.g., a virtual reality (VR) device, an augmented reality (AR) device, or a mixed reality (MR) device), a head-mounted display (HMD) device, a wireless communication device, a mobile device (e.g., a mobile telephone and/or mobile handset and/or so-called “smart phone” or other mobile device), a camera, a personal computer, a laptop computer, a server computer, a vehicle or a computing device or component of a vehicle, another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, any combination thereof, and/or other sensor).

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a diagram illustrating an example wireless communications system, in accordance with some aspects of the present disclosure.

FIGS. 2A and 2B are diagrams illustrating example wireless network structures, in accordance with some aspects of the present disclosure.

FIG. 3 is a diagram of a user equipment (UE) in a wireless communication system that determines a location based on distances from terrestrial transmitting devices, according to some aspects of the present disclosure.

FIG. 4 in as illustration of a carrier phase measurement to determine a distance between a transmitting device and a receiving device based on a phase measurement combination, according to some aspects of the present disclosure.

FIG. 5 is a graph that illustrates the equivalent distances of subcarrier pairs based on subcarrier spacing of an orthogonal frequency division multiplexing (OFDM) system, according to some aspects of the present disclosure.

FIG. 6 is a sequence diagram of a process for configuring a UE to measure subcarrier pairs transmitted from a transmission-reception point (TRP) and location management function (LMF) for determining a distance from the UE to the TRP, according to some aspects of the present disclosure.

FIG. 7A is an illustration of wireless communication system and different subcarrier pair configurations for measuring phase and determining a location from a transmitting device, according to some aspects of the present disclosure.

FIG. 7B is an illustration of wireless communication system and combining phase measurements of different subcarrier pair configurations to improve determining a location from a transmitting device, according to some aspects of the present disclosure.

FIG. 8 is another sequence diagram of a process for configuring a UE to measure subcarrier pairs transmitted from a TRP and LMF for determining a distance from the UE to the TRP, according to some aspects of the present disclosure.

FIG. 9 is a flow chart illustrating an example of a process 900 for wireless communications, according to some aspects of the present disclosure.

FIG. 10 is a flow chart illustrating an example of a process 900 for wireless communications, according to some aspects of the present disclosure.

FIG. 11 illustrates an example block diagram of a computing system of a UE, in accordance with some aspects of the present disclosure.

FIG. 12 illustrates an example computing system, according to aspects of the disclosure.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The ensuing description provides example aspects only, and is not intended to limit the scope, applicability, or configuration of the disclosure. Rather, the ensuing description of the exemplary aspects will provide those skilled in the art with an enabling description for implementing an aspect of the disclosure. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

As noted above, 5G mobile standard calls for higher data transfer speeds, greater numbers of connections, and better coverage, among other improvements. 5G is expected to support several hundreds of thousands of simultaneous connections. Consequently, there is room to improve the spectral efficiency of 5G mobile communications by enhancing signaling efficiencies and reducing latency. One aspect where such signaling efficiency and reduction in latency can be achieved is the communication of various uplink and downlink reference signals between user equipment and their respective serving base stations.

Reference signals are predefined signals occupying specific resource elements within a time-frequency grid of a resource block and may be exchanged on one or both of downlink and uplink physical communication channels. Each reference signal has been defined by the 3^{rd} Generation Partnership Project (3GPP) for a specific purpose, such as for channel estimation, phase-noise compensation, acquiring downlink/uplink channel state information, time and frequency tracking, among others.

Example reference signals include, but are not limited to, Positioning Reference Signal (PRS), Sounding Reference Signal (SRS), Channel State Information-Reference Signal (CSI-RS), De-Modulation Reference Signal (DMRS), among others. Some reference signals (e.g., PRS, CSI-RS, etc.) are downlink specific signals, while others such as DMRS are sent both on downlink and uplink communication channels. There are also uplink specific reference signals defined by the 3GPP.

Reference signals may be used to determine location measurements using a carrier phase positioning based technique. For example, carrier phase positioning can include measuring the phase a received carrier or subcarrier signal (e.g., a subcarrier of a reference signal, such as a PRS), and using the phase to determine a distance from a transmitter of the signal to a receiver of the signal. In some cases, a phase measurement combination or “wide-laning” can be performed by determining phase differences between the received phases of a pair of subcarrier signals (where each pair of subcarriers can be referred to as a “lane”) and mapping the phase difference to the distance between the transmitting device and the receiving device. In some cases, the phase differences can be determined by subtracting the received phases of the pair of subcarrier signals.

Systems, apparatuses, processes (also referred to as methods), and computer-readable media (collectively referred to herein as systems and techniques) are described herein for providing improved carrier phase positioning. In some implementations, determining distances between a transmitting device (e.g., a gNB or other network device or portion thereof) and a receiving device (e.g., a UE) based on phase measurements is an iterative process and multiple phase measurements of different subcarriers may be desired, for example, due to a coarse accuracy of an initial measurement. The systems and techniques described herein provide for techniques for reporting phase measurement capabilities and selecting phase measurements. For example, a network entity (e.g., a location server such as a location management function (LMF), a base station, or portion thereof such as in a distributed architecture) and a device (e.g., a UE) may exchange information to provide the network entity with phase measurement capabilities of the device and to allow the device to select or determine phase measurements for carrier phase positioning.

In some aspects, the device may transmit a message to the network entity reporting a phase measurement granularity of the device. In some cases, the network entity can send a message to the device requesting a measurement step size (also referred to as step size) for all phase measurements (e.g., phase differences between subcarrier pairs) or a respective measurement step size for each phase measurement separately. The device can then report the measured phase measurement(s) with a selected step size from the measurement step sizes requested by the network entity.

Various other types of information can be exchanged between the device and the network entity to improve carrier positioning operations. In some examples, the network entity and the UE can negotiate a phase measurement quality, such as measurement step size or a measurement accuracy, based on device capability and channel conditions such as multipath. In other aspects, the systems and techniques provide mechanisms for selection of phase measurement capabilities without a negotiation. In some aspects, the systems and techniques can be combined with other positioning techniques to improve measurement latency and accuracy of positioning techniques by combining disparate types of measurements.

The systems and techniques described herein can be applied to communications between a network entity (e.g., a base station, location server, etc.) and a user device (e.g., a UE) or to communications between user devices (e.g., between UEs, vehicles, etc.) using sidelink communications (e.g., a cellular based PC5 sidelink interface, 802.11p defined Dedicated Short Range Communication (DSRC) interface, or other direct interface).

The systems and techniques described herein can improve user device (e.g., UE) location estimates or positioning based on the enhanced reference signals described herein. For instance, as noted above, the comb structures described herein can provide enhanced carrier phase measurements for carrier phase positioning. As used herein, a location estimate may be referred to by other names, such as a position estimate, location, location measurement, position, position fix, fix, or the like. A location estimate may be geodetic and may include coordinates (e.g., latitude, longitude, and possibly altitude) or may be civic and include a street address, postal address, or some other description of a location. A location estimate may further be defined relative to some other known location or defined in absolute terms (e.g., using latitude, longitude, and/or altitude). A location estimate may include an expected error or uncertainty (e.g., by including an area or volume within which the location is expected to be included with some specified or default level of confidence).

Additional aspects of the present disclosure are described in more detail below.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

A network entity can be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity” or “base station” (e.g., with an aggregated/monolithic base station architecture or disaggregated base station architecture) may refer to a single physical transmission-reception point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

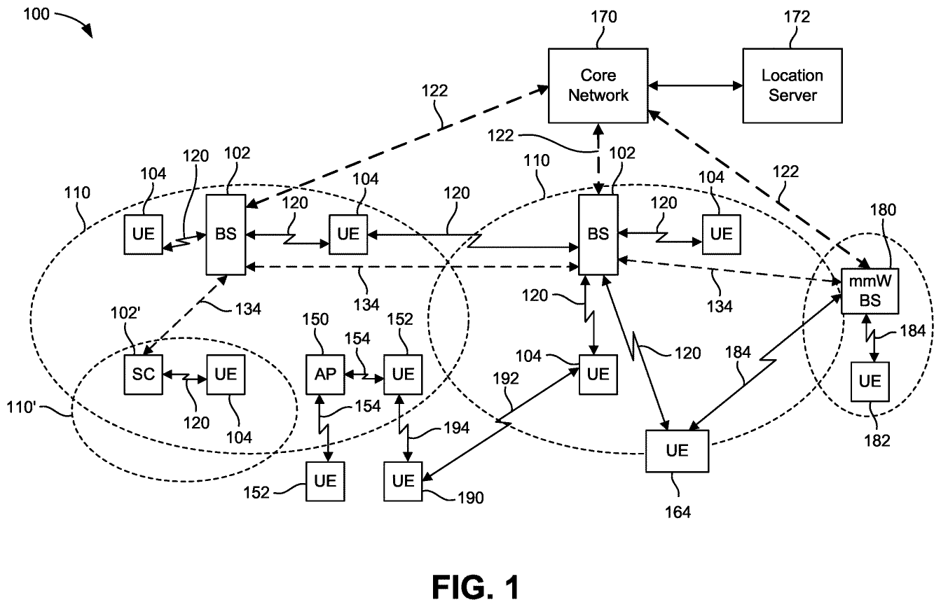

According to various aspects, FIG. 1 illustrates an exemplary wireless communications system 100. The wireless communications system 100 (which may also be referred to as a wireless wide area network (WWAN)) can include various base stations 102 and various UEs 104. In some aspects, the base stations 102 may also be referred to as “network entities” or “network nodes.” One or more of the base stations 102 can be implemented in an aggregated or monolithic base station architecture. Additionally or alternatively, one or more of the base stations 102 can be implemented in a disaggregated base station architecture, and may include one or more of a CU, a DU, an RU, a Near-RT RIC, or a Non-Real Time (Non-RT) RIC. The base stations 102 can include macro cell base stations (high power cellular base stations) and/or small cell base stations (low power cellular base stations). In an aspect, the macro cell base station may include eNBs and/or ng-eNBs where the wireless communications system 100 corresponds to a long term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 can include devices (e.g., UEs, etc.) that communicate with one or more UEs 104, base stations 102, APs 150, etc. utilizing the ultra-wideband (UWB) spectrum. The UWB spectrum can range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node or entity (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while canceling to suppress radiation in undesired directions.

Transmit beams may be quasi-collocated, meaning that they appear to the receiver (e.g., a UE) as having the same parameters, regardless of whether or not the transmitting antennas of the network node themselves are physically collocated. In NR, there are four types of quasi-collocation (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receiving beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain of other beams available to the receiver. This results in a stronger received signal strength, (e.g., reference signal received power (RSRP), reference signal received quality (RSRQ), signal-to-interference-plus-noise ratio (SINR), etc.) of the RF signals received from that direction.

Receive beams may be spatially related. A spatial relation means that parameters for a transmit beam for a second reference signal can be derived from information about a receive beam for a first reference signal. For example, a UE may use a particular receive beam to receive one or more reference downlink reference signals (e.g., positioning reference signals (PRS), tracking reference signals (TRS), phase tracking reference signal (PTRS), cell-specific reference signals (CRS), channel state information reference signals (CSI-RS), primary synchronization signals (PSS), secondary synchronization signals (SSS), synchronization signal blocks (SSBs), etc.) from a network node or entity (e.g., a base station). The UE can then form a transmit beam for sending one or more uplink reference signals (e.g., uplink positioning reference signals (UL-PRS), sounding reference signal (SRS), demodulation reference signals (DMRS), PTRS, etc.) to that network node or entity (e.g., a base station) based on the parameters of the receive beam.

Note that a “downlink” beam may be either a transmit beam or a receive beam, depending on the entity forming it. For example, if a network node or entity (e.g., a base station) is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a network node or entity (e.g., a base station) is forming the uplink beam, it is an uplink receive beam, and if a UE is forming the uplink beam, it is an uplink transmit beam.

In 5G, the frequency spectrum in which wireless network nodes or entities (e.g., base stations 102/180, UEs 104/182) operate is divided into multiple frequency ranges, FR1 (from 450 to 6000 Megahertz (MHz)), FR2 (from 24250 to 52600 MHz), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (x component carriers) for transmission in each direction. The component carriers may or may not be adjacent to each other on the frequency spectrum. Allocation of carriers may be asymmetric with respect to the downlink and uplink (e.g., more or less carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In order to operate on multiple carrier frequencies, a base station 102 and/or a UE 104 is equipped with multiple receivers and/or transmitters. For example, a UE 104 may have two receivers, “Receiver 1” and “Receiver 2,” where “Receiver 1” is a multi-band receiver that can be tuned to band (i.e., carrier frequency) ‘X’ or band ‘Y,’ and “Receiver 2” is a one-band receiver tuneable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (an SCell) in order to measure band ‘Y’ (and vice versa). In contrast, whether the UE 104 is being served in band ‘X’ or band ‘Y,’ because of the separate “Receiver 2,” the UE 104 can measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

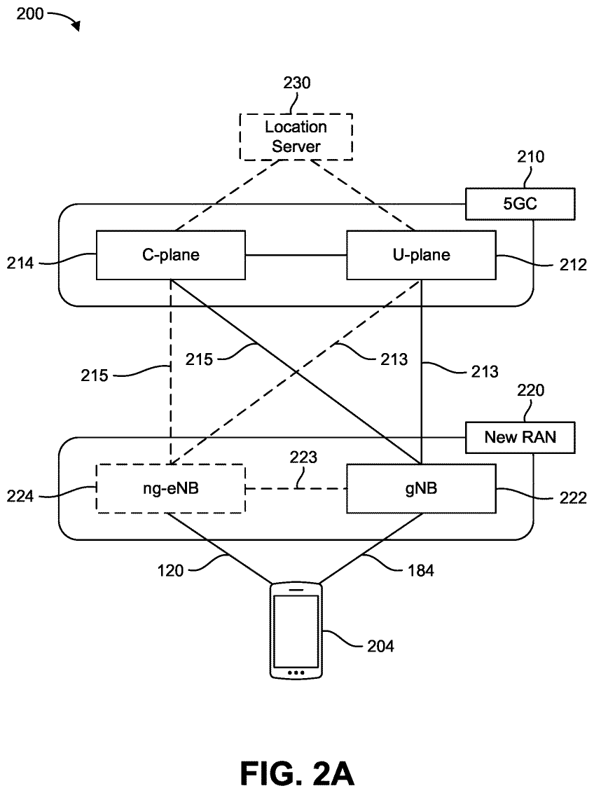

According to various aspects, FIG. 2A illustrates an example wireless network structure 200. For example, a 5GC 210 (also referred to as a Next Generation Core (NGC)) can be viewed functionally as control plane functions 214 (e.g., UE registration, authentication, network access, gateway selection, etc.) and user plane functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the control plane functions 214 and user plane functions 212. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, the New RAN 220 may only have one or more gNBs 222, while other configurations include one or more of both ng-eNBs 224 and gNBs 222. Either gNB 222 or ng-eNB 224 may communicate with UEs 204 (e.g., any of the UEs depicted in FIG. 1).

Another optional aspect may include location server 230, which may be in communication with the 5GC 210 to provide location assistance for UEs 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated with a component of the core network, or alternatively may be external to the core network. In some examples, the location server 230 can be operated by a carrier or provider of the 5GC 210, a third party, an original equipment manufacturer (OEM), or other party. In some cases, multiple location servers can be provided, such as a location server for the carrier, a location server for an OEM of a particular device, and/or other location servers. In such cases, location assistance data can be received from the location server of the carrier and other assistance data can be received from the location server of the OEM.

According to various aspects, FIG. 2B illustrates another example wireless network structure 250. For example, a 5GC 260 can be viewed functionally as control plane functions, provided by an access and mobility management function (AMF) 264, and user plane functions, provided by a user plane function (UPF) 262, which operate cooperatively to form the core network (i.e., 5GC 260). User plane interface 263 and control plane interface 265 connect the ng-eNB 224 to the 5GC 260 and specifically to UPF 262 and AMF 264, respectively. In an additional configuration, a gNB 222 may also be connected to the 5GC 260 via control plane interface 265 to AMF 264 and user plane interface 263 to UPF 262. Further, ng-eNB 224 may directly communicate with gNB 222 via the backhaul connection 223, with or without gNB direct connectivity to the 5GC 260. In some configurations, the New RAN 220 may only have one or more gNBs 222, while other configurations include one or more of both ng-eNBs 224 and gNBs 222. Either gNB 222 or ng-eNB 224 may communicate with UEs 204 (e.g., any of the UEs depicted in FIG. 1). The network nodes or network entities (e.g., base stations) of the New RAN 220 communicate with the AMF 264 over the N2 interface and with the UPF 262 over the N3 interface.

The functions of the AMF 264 include registration management, connection management, reachability management, mobility management, lawful interception, transport for session management (SM) messages between the UE 204 and a session management function (SMF) 266, transparent proxy services for routing SM messages, access authentication and access authorization, transport for short message service (SMS) messages between the UE 204 and the short message service function (SMSF) (not shown), and/or security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the New RAN 220 and the LMF 270, evolved packet system (EPS) bearer identifier allocation for interworking with the EPS, and UE 204 mobility event notification. In addition, the AMF 264 also supports functionalities for non-3GPP access networks.

Functions of the UPF 262 include acting as an anchor point for intra/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., uplink and/or downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as a secure user plane location (SUPL) location platform (SLP) 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

In some aspects, location and positioning functions can be aided by a LMF 270 that is configured for communication with the 5GC 260, e.g., to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, New RAN 220, and UEs 204 over a control plane (e.g., using interfaces and protocols intended to convey signaling messages and not voice or data), the SLP 272 may communicate with UEs 204 and external clients (not shown in FIG. 2B) over a user plane (e.g., using protocols intended to carry voice and/or data like the transmission control protocol (TCP) and/or IP).

In an aspect, the LMF 270 and/or the SLP 272 may be integrated with a network node or entity (e.g., base station), such as the gNB 222 and/or the ng-eNB 224. When integrated with the gNB 222 and/or the ng-eNB 224, the LMF 270 and/or the SLP 272 may be referred to as a “location management component,” or “LMC.” However, as used herein, references to the LMF 270 and the SLP 272 include both the case in which the LMF 270 and the SLP 272 are components of the core network (e.g., 5GC 260) and the case in which the LMF 270 and the SLP 272 are components of a network node or entity (e.g., base station).

As discussed herein, NR supports a number of cellular network-based positioning technologies, including downlink-based, uplink-based, and downlink-and-uplink-based positioning methods. For example, the LMF 270 can enable positioning based on location measurements computed for various positioning signal (PRS or SRS) resources. As used herein, “PRS resource set” is a set of PRS resources used for the transmission of PRS signals, where each PRS resource has a PRS resource identifier (ID). In addition, the PRS resources in a PRS resource set are associated with the same TRP. A PRS resource set is identified by a PRS resource set ID and is associated with a particular TRP (e.g., identified by a TRP ID). In addition, the PRS resources in a PRS resource set have the same periodicity, a common muting pattern configuration, and the same repetition factor (e.g., PRS-ResourceRepetitionFactor) across slots. The periodicity is the time from the first repetition of the first PRS resource of a first PRS instance to the same first repetition of the same first PRS resource of the next PRS instance. The periodicity may have a length selected from 2^{μ}·{4, 5, 8, 10, 16, 20, 32, 40, 64, 80, 160, 320, 640, 1280, 2560, 5120, 10240} slots, with μ=0, 1, 2, 3. The repetition factor may have a length selected from {1, 2, 4, 6, 8, 16, 32} slots.

In some cases, a PRS resource ID in a PRS resource set is associated with a single beam (and/or beam ID) transmitted from a single TRP (where a TRP may transmit one or more beams). For example, each PRS resource of a PRS resource set may be transmitted on a different beam, and as such, a “PRS resource,” or simply “resource,” can also be referred to as a “beam.” Note that this does not have any implications on whether the TRPs and the beams on which PRS are transmitted are known to the UE.

A “PRS instance” or “PRS occasion” is one instance of a periodically repeated time window (e.g., a group of one or more consecutive slots) where PRS are expected to be transmitted. A PRS occasion may also be referred to as a “PRS positioning occasion,” a “PRS positioning instance,” a “positioning occasion,” “a positioning instance,” a “positioning repetition,” or simply an “occasion,” an “instance,” or a “repetition.”

A “positioning frequency layer” (also referred to simply as a “frequency layer” or “layer”) is a collection of one or more PRS resource sets across one or more TRPs that have the same values for certain parameters. Specifically, the collection of PRS resource sets has the same subcarrier spacing (SCS) and cyclic prefix (CP) type (meaning all numerologies supported for the PDSCH are also supported for PRS), the same Point A, the same value of the downlink PRS bandwidth, the same start PRB (and center frequency), and the same comb size. The Point A parameter takes the value of the parameter ARFCN-ValueNR (where “ARFCN” stands for “absolute radio-frequency channel number”) and is an identifier and/or code that specifies a pair of physical radio channel used for transmission and reception. The downlink PRS bandwidth may have a granularity of four PRBs, with a minimum of 24 PRBs and a maximum of 272 PRBs. Currently, up to four frequency layers have been defined, and up to two PRS resource sets may be configured per TRP per frequency layer.

The concept of a frequency layer is somewhat like the concept of component carriers and bandwidth parts (BWPs), but different in that component carriers and BWPs are used by one network node or entity (e.g., a base station, or a macro cell base station and a small cell base station) to transmit data channels, while frequency layers are used by several (usually three or more) a network nodes or entities (e.g., base stations) to transmit PRS. A UE may indicate the number of frequency layers it can support when it sends the network its positioning capabilities, such as during an LTE positioning protocol (LPP) session. For example, a UE may indicate whether it can support one or four positioning frequency layers.

Downlink-based location measurements can include observed time difference of arrival (OTDOA) in LTE, downlink time difference of arrival (DL-TDOA) in NR, and downlink angle-of-departure (DL-AoD) in NR. In an OTDOA or DL-TDOA positioning procedure, a UE measures the differences between the times of arrival (ToAs) of reference signals (e.g., PRS, TRS, NRS, CSI-RS, SSB, etc.) received from pairs of network nodes or entities (e.g., base stations), referred to as reference signal time difference (RSTD) or time difference of arrival (TDOA) measurements, and reports them to a positioning entity. More specifically, the UE receives the identifiers of a reference network node or entity (e.g., a serving base station) and multiple non-reference network nodes or entities (e.g., base stations) in assistance data. The UE then measures the RSTD between the reference network node or entity (e.g., reference base station) and each of the non-reference network nodes or entities (e.g., non-reference base stations). Based on the known locations of the involved network nodes/entities (e.g., base stations) and the RSTD measurements, the positioning entity (e.g., LMF 270) can estimate the UE's location. For DL-AoD positioning, a network node or entity (e.g., a base station such as gNB 222) measures the angle and other channel properties (e.g., signal strength) of the downlink transmit beam used to communicate with a UE to estimate the location of the UE.

Uplink-based positioning methods include uplink time difference of arrival (UL-TDOA) and uplink angle-of-arrival (UL-AoA). UL-TDOA is similar to DL-TDOA, but is based on uplink reference signals (e.g., SRS) transmitted by the UE. For UL-AoA positioning, a network node or entity (e.g., a base station) measures the angle and other channel properties (e.g., gain level) of the uplink receive beam used to communicate with a UE to estimate the location of the UE.

Downlink-and-uplink-based positioning methods include enhanced cell-ID (E-CID) positioning and multi-round-trip-time (RTT) positioning (also referred to as “multi-cell RTT or multi RTT”). In an RTT procedure, an initiator (a network node or entity, such as a base station, or a UE) transmits an RTT measurement signal (e.g., a PRS or SRS) to a responder (a UE or base station), which transmits an RTT response signal (e.g., an SRS or PRS) back to the initiator. The RTT response signal includes the difference between the ToA of the RTT measurement signal and the transmission time of the RTT response signal, referred to as the reception-to-transmission (Rx-Tx) measurement. The initiator calculates the difference between the transmission time of the RTT measurement signal and the ToA of the RTT response signal, referred to as the “Tx-Rx” measurement. The propagation time (also referred to as the “time of flight”) between the initiator and the responder can be calculated from the Tx-Rx and Rx-Tx measurements. Based on the propagation time and the known speed of light, the distance between the initiator and the responder can be determined. For multi-RTT positioning, a UE performs an RTT procedure with multiple network nodes or entities (e.g., base stations) to enable its location to be determined (e.g., using multilateration) based on the known locations of the a network nodes (e.g., base stations). RTT and multi-RTT methods can be combined with other positioning techniques, such as UL-AoA and DL-AoD, to improve location accuracy.

To assist positioning operations, a location server (e.g., location server 230, LMF 270, or other location server) may provide assistance data to the UE. For example, the assistance data may include identifiers of the network nodes or entities (e.g., base stations or the cells and/or TRPs of the base stations) from which to measure reference signals, the reference signal configuration parameters (e.g., the number of consecutive positioning subframes, periodicity of positioning subframes, muting sequence, frequency hopping sequence, reference signal ID, reference signal bandwidth, etc.), and/or other parameters applicable to the particular positioning method. Alternatively, the assistance data may originate directly from the network nodes or entities (e.g., base stations) themselves, such as in periodically broadcasted overhead messages, etc. In some cases, the UE may be able to detect neighbor network nodes itself without the use of assistance data.

For DL-AoD, the UE 204 can provide DL-PRS beam RSRP measurements to the LMF 270, whereas the gNB 222 can provide the beam azimuth and elevation angle information. When using an UL angle of arrival (AoA) positioning method, the position of UE 204 is estimated based on UL SRS AoA measurements taken at different TRPs (not illustrated). For example, TRPs can report AoA measurements directly to LMF 270. Using angle information (e.g., angle of departure (AoD) or AoA) together TRP co-coordinate information and beam configuration details, the LMF 270 can estimate a location of UE 204.

For multi-RTT location measurements, the LMF 270 can initiate a procedure whereby multiple TRPs (not illustrated) and a UE perform the gNB Rx-Tx and UE Rx-Tx measurements, respectively. For example, the gNB 222 and UE 204 can transmit a downlink positioning reference signal (DL-PRS) and uplink sounding reference signal (UL-SRS), respectively, whereby the gNB 222 configures UL-SRS to the UE 204 e.g., using the RRC protocol. In turn, the LMF 270 can provide the DL-PRS configuration to the UE 204. Resulting location measurements are reported to the LMF 270 by the UE 204 and/or gNB 222 to perform location estimation for the UE 204.

The 3rd Generation Partnership (3GPP) (e.g., Technical Specification (TS) TS22.261 and others) requires location measurements of devices (e.g., UEs) with sub-meter level performance. Conventional approaches to determining location measurements using terrestrial systems determine a distance using a “code-phase” or an RSTD measurement technique based on a ToA of the signal. In one example of an RSTD measurement, a UE receives signals from several neighboring eNBs and the ToA from each eNB are subtracted from the ToA of a reference eNB to yield an observed time difference of arrival (ODToA) of each neighboring eNBs. Each ODToA determines a hyperbola based on a known function, and a point at which the hyperbolas intersect corresponds to the location of the UE. At least three different timing measurements from geographically dispersed eNBs with good geometry are needed to solve for two coordinates (e.g., latitude and longitude) of the UE. RSTD measurements cannot satisfy the requirement of location measurement with sub-meter level performance due to timing errors and location errors that propagate into each ODToA measurement and reduce the accuracy of the location measurement.

A terrestrial-based system may implement an AoD method or a Zenith angle of departure (ZoD) method to provide better accuracy and resource utilization within a 3GPP system. There are contributions proposing the use of phase measurement for improving 5G/NR location measurements, however, the feasibility and performance of such proposals have not been sufficiently studied in 3GPP.

In some cases, phase measurement-based location measurements can be achieved using a non-terrestrial system, such as a Global Navigation Satellite System (GNSS), that employs carrier phase positioning techniques to provide centimeter-level accuracy. Carrier phase positioning can be performed by determining timing and/or distance measurements using a wavelength of a subcarrier signal. In contrast to RSTD measurement techniques, carrier phase positioning estimate a phase of a subcarrier signal in the frequency domain.

One example of GNSS measurement techniques that provide sub-meter level performance use real-time kinematic positioning (RTK) to improve the accuracy of current satellite navigation (e.g., GNSS based) systems by configuring a network entity (e.g., a base station such as an eNB, a gNB, etc.) to measure the subcarrier signal and the network entity retransmits the measured phase of the carrier signal to a UE. The UE also measures the phase of the carrier signal from the satellite and compares the phase measurement at the UE and the phase measurement at the network entity to determine the distance of the mobile device from the network entity. While RTK positioning provides better accuracy over conventional GNSS measurement approaches, the accuracy is limited based on the accuracy of the network entity (e.g., the base station), line-of-sight to the satellite, and environmental conditions that can affect the measurements from the satellite system. For example, buildings can create reflections that increase phase error measured by the mobile device and cloudy conditions. RTK positioning is also limited to outdoor environments due to the receiver device requiring a line-of-sight to the satellites.

Bluetooth can also use carrier phase measurement for providing centimeter-level high accuracy positioning services but is limited to indoor environments due to the limited range of Bluetooth communication. Carrier phase measurement with Bluetooth may be inaccurate because the reference devices that transmit the carrier signals may not be fixed and inaccuracies in the location of the reference devices propagate into the carrier phase measurement.

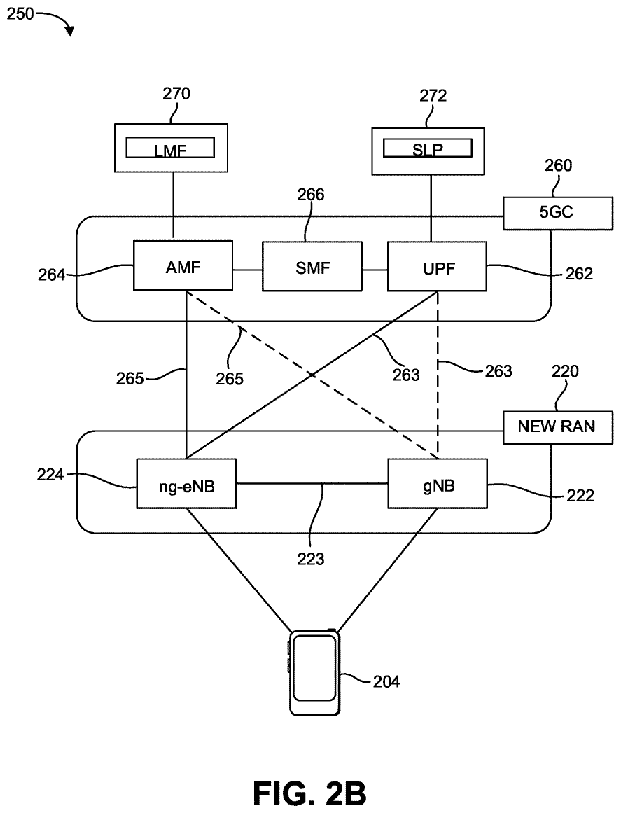

FIG. 3 is a diagram of a UE 305 in a wireless communication system 300 that determines a location based on distances from terrestrial transmitting devices, according to some aspects of the present disclosure. Although FIG. 3 illustrates determining a location of the UE 305 in a wireless networking system relative to network entities 310, 315, and 320, this non-limiting illustration is for explanation purposes and the descriptions herein can be applied to other systems. In another illustrative example, the UE 305 may be a vehicle that employs vehicle-to-everything (V2X) communications with other vehicles or UEs to determine locations relative to other vehicles or objects to perform various driving functions such as lane assist, blind-spot detection, autonomous driving functions, and the like.

As shown in FIG. 3, the wireless communication system 300 includes the UE 305 positioned relative to a network entity 310, a network entity 315, and a network entity 320. In some cases, one or more of the network entities 310, 315, and 320 can be implemented in an aggregated or monolithic base station architecture or in a disaggregated base station architecture (e.g., including one or more of a CU, a DU, a RU, a Near-RT RIC, or a Non-RT RIC). Each of the network entities 310, 315, and 320 transmits a carrier signal that is received by the UE 305. In particular, the network entity 310 transmits the carrier signal 322, the network entity 315 transmits the carrier signal 324, and the network entity 320 transmits the carrier signal 326. In some aspects, the UE 305 can be configured to measure a distance L1 to network entity 310, a distance L2 to network entity 315, and a distance L3 to network entity 320. In one illustrative example, the UE 305 can determine its location based on the distances L1, L2, and L3 and the locations of each of the network entities 310, 315, and 320. In other examples, the UE can measure a parameter such as a carrier phase and transmit the measured parameter to another device, such as a location server (e.g., an LMF), that determines the location of the UE.

In some aspects, the wireless communication system 300 is a system configured to transmit using subcarriers across various frequencies. For instance, the wireless communication system 300 may be an orthogonal frequency division multiplexing (OFDM) system configured to transmit in a licensed frequency band or an unlicensed frequency band using subcarriers that are spaced across the frequency band.

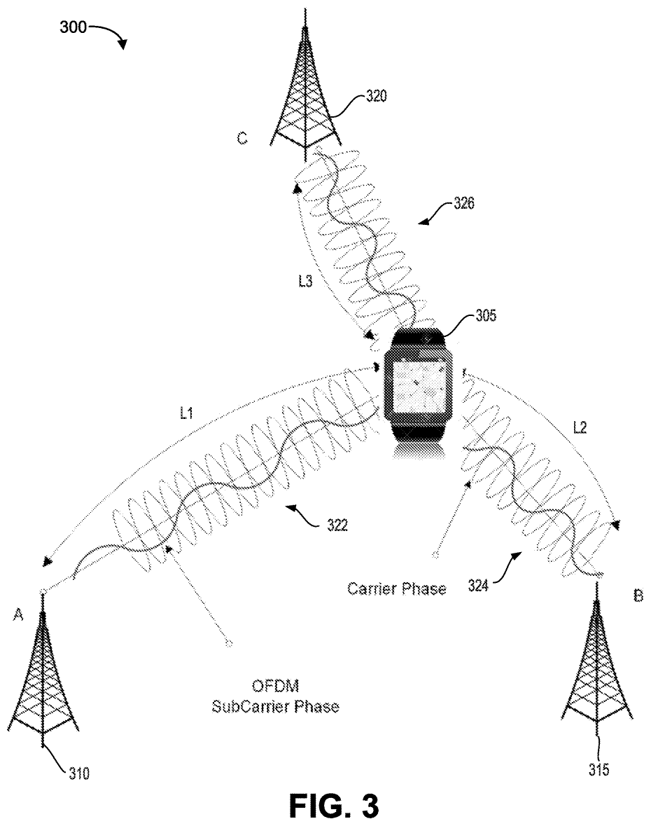

FIG. 4 is an illustration of a transmitting device 405 communicating with a receiving device 410 via signal 420 and a signal 425. The signals 420 and 425 may be subcarrier signals. The transmitting device or the receiving device 410 may be configured to determine a carrier phase measurement that can be used to determine a distance between the transmitting device 405 and the receiving device 410 based on a phase measurement combination. In some aspects, the transmitting device 405 or the receiving device 410 can determine the carrier phase measurement and/or the distance. For instance, the receiving device 410 may determine the carrier phase measurement and may transmit the carrier phase measurement to the transmitting device 405. In another example, the receiving device 410 may determine the carrier phase measurement and may transmit the carrier phase measurement to another network entity, such as a location server (e.g., an LMF). The location server may receive the carrier phase measurement and determine the distance between the transmitting device 405 and the receiving device 410 using the carrier phase measurement. In some examples, the location server may receive distances between one or more other receiving devices and the transmitting device 405. The location server can use the distance determined for the receiving device 410 and the distances between one or more other receiving devices and the transmitting device 405 to determine a location of the receiving device 410 and/or the other receiving devices (e.g., by performing triangulation using the locations).

The signal 420 and the signal 425 are sinusoidal signals. The signal 420 has a wavelength denoted as λ₁ in FIG. 4 and the signal 425 has a wavelength denoted as λ₂. There are an integer number of wavelength cycles for each of the signals (e.g., subcarrier signals), including an integer number Nλ₁ for the signal 420 and an integer number Nλ₂ for the signal 425, as shown in FIG. 4. The receiving device 410 can measure the phase 430 of the signal 420 when the signal 420 is received and can measure the phase 435 of the signal 425 when the signal 425 is received. As shown, there is a fractional wavelength (shown as fractional wavelength λᵢ₁ for the signal 420 and λᵢ₂ for the signal 425) between the beginning of the last period or wavelength and when the signal is received by the receiving device 410. The receiving device 410 can perform carrier phase measurements by first determining the phase at which a signal is received (e.g., the phase 430 of the signal 420) and how many integer number (e.g., Nλ₁ or Nλ₂) of wavelengths have passed. For instance, the distance μ between the transmitting device 405 and the receiving device 410 can be determined based on the integer number (e.g., Nλ₁ or Nλ₂) of wavelength cycles of a signal (e.g., the signal 420 and/or the signal 425) and the fractional wavelength (e.g., λᵢ₁ or λᵢ₂). In one illustrative example, if the wavelength λ1 is 10 centimeters (cm) and the integer number Nλ₁ of wavelength cycles is 1000, then the distance ρ between the transmitting device 405 and a receiving device 410 can be determined as 10 meters (m) (based on 0.01 m×1000) plus a distance associated with the fractional wavelength λᵢ₁.

As noted above, the general concept of carrier phase measurements (e.g., for carrier/subcarrier-based positioning) is that any distance ρ between a transmitting device 405 (e.g., an eNB, a gNB, etc.) and a receiving device 410 (e.g., a UE) can be represented in terms of N full wavelengths λ and the residual fractional wavelength λᵢ of the subcarrier signal. In mathematical terms, the principle of estimating distance (ρ, also referred to as d) using a carrier phase can be given as follows:

$$ρ = N λ + \frac{ϕ}{2 π} λ \qquad ( Equation 1 )$$

where Nλ is the integer number of wavelength cycles

$$\frac{ϕ}{2 π} λ$$

is the residual fractional wavelength λᵢ of the subcarrier signal (where the phase φ is divided by 2π if the phase is in radians). The wavelength λ of a signal can be determined based c/f, where c is the speed of light (299,792,458 meters per second) and f is the frequency of the signal. For example, a frequency of 3 GHz has a wavelength of 10 centimeters (cm) and a frequency of 500 kilohertz (kHz) has a wavelength of 600 meters. The fractional wavelength (e.g., λᵢ₁ in FIG. 4 or

$$\frac{ϕ}{2 π} λ$$

in Equation (1)) can be determined using a carrier phase measurement.

Measuring the phase φ of the received subcarrier signal will only provide the fractional wavelength λᵢ because the carrier phase is periodic. As noted above, the distance ρ between the transmitting device 405 and the receiving device 410 can be determined based on the integer number (e.g., Nλ₁ or Nλ₂) of wavelength cycles of a signal (e.g., the signal 420 and/or the signal 425) and a distance associated with the fractional wavelength (e.g., λᵢ₁ or λᵢ₂). However, typical carrier-phase measurements of a signal can only be used to determine the fractional phase term, as the term N is ambiguous (and cannot be directly measured) because the carrier phase is periodic. For example, a signal may be received by the receiving device 410 with a carrier phase of 0.5π (e.g., 90°), or a length of 2.5 cm for a 3 GHz signal, but the signal may have traveled 2.5 cm, 12.5 cm, or 102.5 cm. The receiving device 410 receives the signal 420 with a fractional wavelength λᵢ₁ and receives the signal 425 with a fractional wavelength λᵢ₂ that is greater than fractional wavelength λᵢ₁ (e.g., based on the signal 425 having a higher frequency than the signal 420, based on being transmitted at different times, etc.). Therefore, an estimation or an inference is required (e.g., via different cycle count techniques) to determine N and thus to determine the distance ρ from the transmitting device 405 to the receiving device 410.

In some aspects, the number of integer cycles N can be inferred and an unknown distance to the receiving device 410 can be determined based on a carrier phase measurement using terrestrial transmitting devices (e.g., a gNB, a beacon, etc.). If the receiving device 410 receives and determines distances to at least two terrestrial transmitting devices that have a known location, the receiving device 410 may be able to determine the location of the receiving device 410 without non-terrestrial sources (e.g., satellites). As noted above, systems and techniques described herein can be used to determine an unknown distance between a transmitting device and a receiving device using carrier phase measurements from terrestrial devices in both indoor and outdoor environments. In some aspects, the systems and techniques disclosed herein can be applied to other non-terrestrial devices in a licensed band or an unlicensed band.

As noted above, the received phase φᵢ of the i^{th} carrier or subcarrier signal (e.g., the phase 430 of the signal 420 shown in FIG. 4) can be measured at the receiving device 410. In particular the carrier phase can be determined based on Equation 2 below.

$${ϕ}_{i} = \frac{2 π ( ρ - {N}_{i} {λ}_{i} )}{{λ}_{i}} + {e}_{{ϕ}_{i}} \qquad ( Equation 2 )$$

In equation 2, Nᵢ is an ambiguous integer of wavelength cycles (as noted above), ρ is the distance between the transmitting device 405 and the receiving device 410, λᵢ is the wavelength of the i^{th} carrier or subcarrier signal, and e_{φ}_{ᵢ} is the noise in the phase measurement. In some aspects, the received frequency domain resource elements (REs) of an OFDM-based reference signal (e.g., PRS, SRS, etc.) channel with a simple delay can be modeled by Equation 3 below:

$${R}_{k} = {D}_{k} {e}^{- \frac{j 2 π k Δ f ρ}{c}} + {W}_{k} \qquad ( Equation 3 )$$

In Equation 3, k corresponds to a subcarrier according to the following:

$$k = - \frac{{N}_{RB}}{2} , … , - 1 , 0 , 1 , … , \frac{{N}_{RB}}{2} ,$$

where N_{RB} is the number of resource blocks (RBs). The term k can be considered a subcarrier index that identifies a frequency of the signal. The term Rₖ in Equation 3 above is the frequency domain RE transmitted on carrier k, Dₖ is the time domain representation of the symbol transmitted on carrier k, and Wₖ is the noise at the subcarrier k. Equation 3 can be further simplified into Equation 4 below.

$${e}_{k} = {D}_{k} {e}^{- \frac{j 2 π k ρ}{{λ}_{Δ}}} + {W}_{k} , where {λ}_{Δ} = \frac{c}{Δ f} \qquad ( Equation 4 )$$

In Equation 4, λ_{Δ} is the wavelength difference of two subcarrier frequencies. After a descrambling operation, the frequency domain PRS REs can be represented by Equations 5 and 6 below.

$${R}_{k}^{′} = {‖ {D}_{k} ‖}^{2} {e}^{- \frac{j 2 π k ρ}{{λ}_{Δ}}} + {D}_{k}^{*} {W}_{k} \qquad ( Equation 5 )$$

$${R}_{k}^{′} = {e}^{- \frac{j 2 π k ρ}{{λ}_{Δ}}} + {W}_{k}^{′} \qquad ( Equation 6 )$$

The carrier phase of a k^{th} subcarrier can be determined based on the arctangent of the imaginary part of the frequency domain PRS RE divided by the real part of frequency domain PRS RE as identified in Equation 7 below.

$${ϕ}_{k} = - {tan}^{- 1} ( \frac{Im \{ {R}_{k}^{′} \}}{Re \{ {R}_{k}^{′} \}} ) = \frac{2 π k ρ}{{λ}_{Δ}} - 2 π {N}_{k} \qquad ( Equation 7 )$$

In this case, Nₖ∈ [symbol] is an ambiguous number of full wavelength cycles that cannot be directly measured, and φₖ∈(−π, π) is the phase observation for the k^{th} sub-carrier.

In some aspects, by combining the carrier phase measurements φ of different subcarriers, the measuring device (e.g., the transmitting device 405, the receiving device 410, or another network entity such as an LMF) may remove the ambiguity of the integer number of cycles N. For example, instead of directly mapping a phase (e.g., the phase 430 of signal 420) to a distance, as described above, a device can subtract the received phases of a pair of subcarrier signals (denoted as φₖ−φₖ₋ₘ below) or a pair of set of subcarriers. A subcarrier set includes at least one subcarrier. One example of a “set of subcarriers” is a set with a single subcarrier. In such an example, a pair of subcarriers would be two subcarriers (as each set would include a single subcarrier). In some examples, “X subcarriers” (e.g., consecutive subcarriers) can be included in a set of subcarriers. In such examples, the measuring device can derive a single phase measurement for the set of subcarriers including X subcarriers. The measuring device can also derive a single phase measurement (e.g., an effective, average, median, or other representative phase of the set of subcarriers) for a second set of subcarriers including the same number (X) of subcarriers or a different number (e.g., Y) of subcarriers. Using the two phase measurements, the measuring device can determine the difference (e.g., φₖ−φₖ₋ₘ as described below with respect to equation 8, where the φₖ is effective, average, median, or other representative phase of the set of subcarriers) between the two phase measurements. The terms subcarrier pair (or pair of subcarriers) and subcarrier set pair (or pair of set of subcarriers) will be used interchangeably herein.

In one illustrative example, for a pair of subcarriers x1, x2, the measuring device (e.g., UE) can derive two phases φ₁, φ₂. For a pair of set of subcarriers {x1a,x1b,x1c, . . . x1w}, {x2a,x2b,x2c, . . . x2w}, the measuring device can derive two phases as follows: φ₁, φ₂ where φ₁ is derived based on {x1a,x1b,x1c, . . . x1w} and φ₂ is derived based on {x2a,x2b,x2c, . . . x2w}. Further details regarding phase differences (e.g., φₖ−φₖ₋ₘ) are as described below with respect to equation 8.

For two subcarriers that are close together in the frequency domain, the wavelengths of the two subcarriers are close together, in which case the number of cycles of the subcarriers between a transmitting device (e.g., transmitting device 405) and a receiving device (e.g., receiving device 410) will be similar. Subtracting the respective phases of the two close-by subcarriers (denoted as

$${λ}_{Δ}^{m} Δ {N}_{m}$$

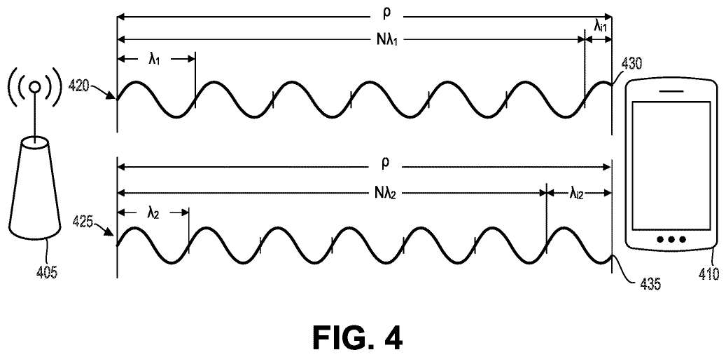

below) will thus result in the number N of wavelength cycles being canceled out or reduced to a negligible value, as shown by the equations below. As a result, as shown in Equation (11) below, the phase difference between the sub-carriers can map directly to the distance d between a transmitting device and a receiving device (e.g., transmitting device 405 and receiving device 410). Such a technique can thus be performed to determine a distance between a transmitting device and a receiving device even in view of the ambiguous number of cycles N. In some aspects, a pair of subcarriers (or pair of set of subcarriers) may be referred to as a “lane,” and the operation of determining the distance from the transmitting device and the receiving device based on the difference in the phase measurements of a subcarrier pair (or subcarrier set pair) can be referred to as a phase measurement combination or “wide-laning”. Examples of various subcarrier pairs/subcarrier set pair and corresponding wavelengths are illustrated in FIG. 5. Mathematical details of phase measurement combining (or wide-laning) using different subcarrier pairs are further detailed below with reference to descriptions related to Equations 8 to 10.

In some aspects, an OFDM system transmits across a licensed or unlicensed frequency band (e.g., 5 GHz) that assigns each subcarrier a distinct center frequency with a fixed bandwidth, and the subcarriers are separated by a subcarrier spacing such as 30 kHz. A subcarrier is associated with a subcarrier index that identifies a distinct center frequency of each distinct subcarrier based on the subcarrier spacing. In some communication systems, subcarriers of a particular frequency band may also be separated by a guard interval to address potential interference from communication devices that are also communicating in that same frequency band. Equation 8 below illustrates how the carrier phase measurements of two different subcarriers, subcarrier k and subcarrier k-m with corresponding carrier phases denoted as φₖ and φₖ₋ₘ, can be combined based on the carrier phase measurement from Equation 7.

$${ϕ}_{k} - {ϕ}_{k - m} = 2 π d \frac{k}{{λ}_{Δ}} - 2 π {N}_{k} - 2 π d \frac{k - m}{{λ}_{Δ}} + 2 π {N}_{k - m} \qquad ( Equation 8 )$$

In some aspects, the number of cycles Nₖ and Nₖ₋ₘ may be equal or may be similar. The phase of the subcarrier pair, being separated by subcarrier difference m, can be compared to yield a phase measurement difference Δφm (as illustrated in Equation 9 below), which can be used to determine a distance d from the transmitting device 405 and receiving device 410 (as illustrated in Equation 10 below).

$${ϕ}_{k} - {ϕ}_{k - m} = Δ {ϕ}_{m} = \frac{2 π d}{\frac{{λ}_{Δ}}{m}} + 2 π ( {N}_{k - m} - {N}_{k} ) = \frac{2 π d}{{λ}_{Δ}^{m}} + 2 π Δ {N}_{m} \qquad ( Equation 9 )$$

Based on equation 9, the phase measurement difference Δφm determined using Equation 9 can be used in Equation 10 below to determine a distance d from a transmitting device (e.g., transmitting device 405) to the receiving device (e.g., receiving device 410).

$$d = {λ}_{Δ}^{m} \frac{Δ {ϕ}_{m}}{2 π} + {λ}_{Δ}^{m} Δ {N}_{m} \qquad ( Equation 10 )$$

where

$${λ}_{Δ}^{m}$$

is the equivalent wavelength of a subcarrier combination with sub-carrier separation of mΔf, m is the subcarrier difference, and Δf is the spacing between subcarriers.

In one illustrative example, a first subcarrier of the subcarrier pair has an index value of 1, corresponding to a subcarrier frequency of 5000.03 MHz, and a second subcarrier of the subcarrier pair has an index value of 2, corresponding to subcarrier frequency of 5000.06 MHz (e.g., a SCS of 30 kHz), with the subcarrier difference of 1. In this example, the subcarriers are spaced at 30 kHz intervals, and the equivalent wavelength

$${λ}_{Δ}^{1}$$

of the subcarrier pair is based on

$$\frac{c}{Δ f} = \frac{299 , 792 , 458 m / s}{( 2 - 1 ) * 30 kHz} ,$$

or approximately 10 kilometers (km). The wavelengths of the subcarriers in this example are nearly equal based on the 30 kHz frequency difference. Because of the similar wavelength of the subcarrier frequencies, the subcarriers will need to travel a large distance before the number of cycles of the higher frequency subcarrier will increase and be different than the number of cycles of the lower frequency subcarrier.

In some aspects, a larger difference in frequencies between subcarrier pairs will increase the difference in wavelengths (ΔNₘ) between the subcarriers in each subcarrier pair. However, the value of ΔNₘ does not need to be zero, since the value of ΔNₘ for each subcarrier pair can be known.

In some cases, there may be a maximum number of RBs that can be assigned to a particular signal (e.g., a PRS, SRS, DMRS, CSI-RS, etc.). For example, there may be a maximum of 272 RBs that are assignable to a PRS. In such an example, presuming a comb 1, symbol 1 RB structure with 12 assignable tones, there are 272×12=3264 different subcarrier assignments. Presuming that the largest subcarrier distance is used (e.g., the first subcarrier having an index of 1 and the last subcarrier having an index value of 3264), the two subcarriers of the subcarrier pair are separated by 3263 subcarriers, and the equivalent wavelength is

$$\frac{299 , 792 , 458 m / s}{3263 \times 30 kHz} = 3 m .$$

If the shortest subcarrier distance is used (e.g., the first subcarrier having an index of 1 and the next subcarrier having an index of 2), then the two subcarriers of the subcarrier pair are separated by 3263 subcarriers, and the equivalent wavelength is

$$\frac{299 , 792 , 458 m / s}{s \times 30 kHz} = 9 , 931 m ( or 10 km ) .$$

In some aspects, there are more subcarrier pairs with a larger equivalent wavelength than subcarrier pairs with a shorter equivalent wavelength. For example, there is a single subcarrier pair combination that yields a subcarrier distance of 3263 (e.g., subcarrier pair [1, 3264]), and there are at 3263 subcarrier pairs having a subcarrier spacing of 1 (e.g., [1, 2], [2, 3], [3, 4], . . . , [3263, 3264]). In some aspects, a narrow subcarrier pair (corresponding to a wide lane) refers to subcarriers that are relatively close together in frequency and have similar wavelengths, and a wide subcarrier pair (corresponding to a narrow lane) refers to subcarriers that are farther apart in frequency and have less similar wavelengths as compared to the narrow subcarrier pairs, which is illustrated herein with reference to FIG. 5.

Different subcarrier combinations may be used to identify an unknown location of a device because a narrow subcarrier pair or a wide subcarrier pair will not be able to produce accurate initial results for every case. For example, a narrow subcarrier group may be inaccurate because the receiving device may be close to the transmitting device (e.g., 200 m), in which case the phase differences of the narrow subcarrier pair may be outside of a measurement sensitivity of a phase measurement device on the receiving device and the measured phase will be dominated by noise (e.g., e_{φ}_{ᵢ}). In the case that phase of each subcarrier measurement is below the noise floor of the measurement (e.g., e_{φ}_{ᵢ}) and the difference in the subcarrier phase is zero, the measured phase yields a distance of zero from the transmitting device to the receiving device. In some aspects, a zero distance indicates that the transmitting device and the receiving device occupy the same physical space, which is not possible. In this case, the narrowest subcarrier group cannot be used to determine the distance between transmitting device 405 and the receiving device 410. The widest subcarrier group also cannot determine the distance between transmitting device 405 and the receiving device 410 because the receiving device 410 is outside of the smallest equivalent wavelength of 3 m and there are an ambiguous number of cycles N.

In some aspects, the wide subcarrier pair can be used if an initial location is known and the number of cycles can be determined. For example, if a location of a receiving device is known within a 3 meter radius, the widest subcarrier pair identified (e.g., subcarrier pair [1, 3264]) above can be used to identify a location in units of centimeters within that 3 meter radius. In some aspects, narrow subcarrier pairs can be used to identify a coarse location within larger areas but with lower accuracy, and then different subcarrier pairs can be used to identify a location within a smaller area but with higher accuracy.

FIG. 5 is a graph that illustrates the wavelengths of subcarrier pairs based on subcarrier spacing of an OFDM system and wavelength differences of the subcarrier pairs, according to some aspects of the present disclosure. In FIG. 5, the equivalent wavelength of the subcarrier pairs are illustrated by reference numeral 505 and the wavelength differences are illustrated by reference numeral 510. As described above, narrower subcarrier pairs have large equivalent wavelengths based on the wavelength of their subcarriers being closer than wider subcarrier pairs.

In some aspects, to address multipath fading, the time domain signal may need additional processing to remove earlier or later multipath signals. An inverse fast Fourier transform (IFFT) may determine that the PRS tone has some multipath components and the tone is converted back into the time domain and a time domain window function is applied to remove earlier or later received multipath signals. After the window function, the time domain representation of the tone is converted back into the frequency domain. In some aspects, techniques to reduce the effects of multipath fading may be expensive due to conversion into the time domain and then conversion back into the frequency domain.

Various systems and techniques are described herein for phase-based measurements in carrier phase positioning. In some aspects, a UE can report (e.g., via signaling in one or more messages to a network entity device, such as an LMF, gNB, etc.) the smallest carrier phase measurements for positioning (e.g., the smallest Δφ which is the phase difference between two subcarriers) that the UE can perform. Such measurement capability can be referred to as carrier phase measurement resolution or granularity. For example, in some cases, a UE can observe a phase difference of 0.1°. In some cases, the carrier phase measurement resolution or granularity of a particular UE can be based on the phase noise profile for the UE. In some cases, a large amount of noise present in the RF components of the UE. In some examples, high-tier UEs with a large amount of computing and/or processing capabilities will have a higher resolution or granularity (e.g., step size) in the measurement of carrier phase, and lower-tier UEs with less computing and/or processing capabilities will have lower resolution or granularity in the measurement of carrier phase. A UE can report its carrier phase measurement resolution or granularity capability in terms of degrees, radians, or other representation.

In some aspects, a network entity device (e.g., as an LMF, gNB, etc.) can request the step size for the carrier phase measurements. In some cases, the network entity device can request a worst-case step size, and the UE can pick that step size or a more granular step size (e.g, the recommended reporting granularity). In some cases, multiple step sizes can be defined (e.g., via newly added language) in a 3GPP technical specification (TS) related to positioning (e.g., in 3GPP TS 37.355). In one illustrative example, the multiple step sizes defined in the TS can be as follows: {1e-1, 1e-2, 1e-3, . . . , 1e-k}.

In some aspects, a network entity device (e.g., as an LMF, gNB, etc.) can request the step size reporting of the carrier phase measurements (e.g., the Δφ measurements) for each lane separately. For instance, a subcarrier pair that has a wide lane can be used to report carrier phase measurements (e.g., the Δφ measurements) in larger step sizes. In another example, a narrow lane can be used to report carrier phase measurements (e.g., the Δφ measurements) in smaller step sizes.

In some aspects, a UE may report the measured carrier phase measurements (e.g., the Δφ measurements) with the chosen step size defined by the LMF. In such aspects, the LMF may configure the step size for the UE based on the UE capability.

In some aspects, the UE may autonomously select the step size and report a carrier phase measurement (e.g., the Δφ measurement) to network entity device (e.g., as an LMF, gNB, etc.). Such aspects may be performed, for instance, when a network entity device (e.g., as an LMF, gNB, etc.) has not configured the step size. In such aspects, the UE may select the step size from predefined step sizes (e.g., predefined step sizes defined in a 3GPP TS, such as 3GPP TS 37.355), such as the example step sizes noted above (e.g., {1e-1, 1e-2, 1e-3, . . . , 1e-k}). In some cases, the UE may determine the step size based on the phase measurement quality. In some examples, the UE may report the step size along with phase measurement report including one or more carrier phase measurements (e.g., the Dphi measurements).

In some aspects, the UE may choose to select a different step size for a phase measurement for different PRS resources. For instance, such aspects can be useful in the case where the UE will choose to measure the different PRS resources with different lane widths.

In some aspects, the UE may use different step sizes for different bands, such as for different positioning frequency layers (PFLs), frequencies, reference signal resources (e.g., PRS resources, sounding reference signal (SRS) resources, demodulation reference signal (DMRS) resources, Channel State Information Reference Signal (CSI-RS) resources, etc.), transmission reception points (TRPs), reference signal resource sets (e.g., PRS resource sets, SRS resource sets, DMRS resource sets, CSI-RS resource sets, etc.).

In some aspects, a UE can be configured with the capability to resolve the minimum narrow lane, such as in terms of wavelength, in terms of frequency, and/or in terms of consecutive sub-carrier difference. In some aspects, a UE can be configured with the capability to resolve the maximum wide lane, such as in terms of wavelength, in terms of frequency, and/or in terms of consecutive sub-carrier difference.

In some aspects, a UE can be configured with the capability to report measurement on maximum number of lanes. Such aspects can be related to UE buffer requirements. For example, a UE can report X number of phase measurement derived from different lanes or different set of reference signal (e.g., PRS, SRS, DMRS, CSI-RS, etc.) carriers.

In some aspects, a UE can be configured with the capability to resolve minimum phase ambiguity. Such aspects can be a measure of internal phase error from different UE components, such as IFFT module, FFT Module, RF chain, group delay, clock error, among others. In some cases, the UE can be calibrated to resolve such ambiguity in a factory setting

Aspects are now described with respect to resource and processing capabilities. In some aspects, a carrier phase positioning technique can have separate characteristics than other positioning methods, such as NR-downlink angle of departure (NR-DL-AOD), NR-Multi-roundtrip time (RTT), or other positioning methods. For instance, each positioning method or technique can have its own configuration for measurement and/or reporting (e.g., measurement and/or reporting granularity or resolution), such as how phase measurements will be reported along with the other positioning method (e.g., AOD, RTT, etc.). In one example, a network entity device (e.g., as an LMF, gNB, etc.) can request that the UE perform carrier phase positioning with a first resolution or granularity and perform NR-DL-AOD with a second granularity. The UE can then report to the network entity the AOD measurements at the second granularity and the phase measurements at the first granularity.

In some aspects, a carrier phase positioning technique can have its own reference signal (e.g., PRS, SRS, DMRS, CSI-RS, etc.) processing capabilities. For instance, one difference of carrier phase positioning processing is that it depends on how many additional path carrier phases the UE needs to report. A “path” refers to a multipath component. For instance, a wireless channel has reflections/scatterers. For example, in multipath fading, a signal has multiple paths due to various reflections in the environment and can be received with small variations. In such cases, multiple copies of a signal may be received at one or more receiving antennas of a receiving device and each copy of the signal has travelled a separate path. The receiving device can detect/estimate those paths and report timing, power, phase information, etc. separately for each path (e.g., a second path may be X dB lower than the earliest path (LOS), Y nanoseconds (ns) later, with a phase difference Z degrees). The receiving device may be able to receive the multipath signals and provide information (e.g., a power differential (e.g., −2 dB), a time differential (e.g., −2 ns), a phase differential, etc.) associated with each path of that signal.

NR positioning techniques (e.g., NR-DL-TDOA, NR-DL-AOD, NR-Multi-RTT, etc.) other than carrier phase positioning-based techniques do not depend on the additional multipath report. In one example, a UE can signal (e.g., via one or more messages to a network entity) an indication of how many additional paths (e.g., including Earliest arrival path (EAP)) the UE can report. In another example, such as when the UE is only reporting the EAP path, the UE can report different sets of processing capabilities and resource capabilities. In another example, such as when the UE is reporting more than one path (e.g., EAP and additional path measurements), the UE can report the different set of processing capabilities and resource capabilities. In some cases, the carrier phase positioning method processing and resource capability of the UE may depend on the detection and report of the additional path measurement report.

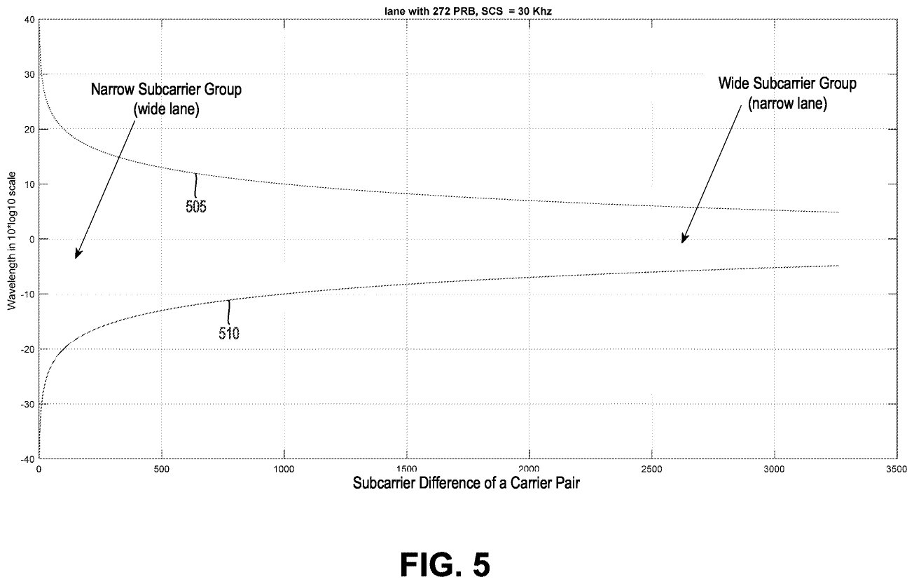

FIG. 6 is a sequence diagram of a process for configuring phase measurements in a wireless communication system, according to some aspects. In some aspects, the wireless communication system includes a UE 602, a TRP 604 configured to transmit reference signals for the UE 602, and an LMF 606 for determining a position or a location of the UE 602. In some examples, the UE 602 may know the characteristics of the reference signal and can compare the received signal with the known characteristics to determine various information such as path loss, time, etc. Non-limiting examples of reference signals that the TRP 604 can transmit and the UE 602 can measure include PRS, TRS, PTRS, CRS, DMRS, CSI-RS, SRS, PSS, SSS, and SSB.

In some aspects, the UE 602 can transmit a capability report 608 to a network entity such as the LMF 606 that includes information related to the UE measurement capabilities. For example, the capability report 608 can include information related to position measurement techniques such as timing capabilities and phase measurement capabilities. In some cases, UEs may have different capabilities in various components that can affect phase measurement accuracy and other timing measurements and may identify various parameters in the capability report. Non-limiting examples of parameters that can affect measurements include clock drift, IFFT window size, IFFT quality, phase measurement step size, phase noise floor, temperature, mobility, and so forth.

In one illustrative example, significant amounts of phase noise in RF components of the UE can prevent the UE from observing any phase difference below the phase noise. For example, if the phase noise is ±5°, any measurement below the phase noise will be dominated by the phase noise. In some aspects, based on the phase noise of ±5°, measuring a phase of a pair of subcarriers that have a very large equivalent wavelength will be inaccurate because the phase noise will also dominate the measurement.

In some cases, phase noise can also be introduced by quantization by an analog-to-digital converter (ADC) and the amount of phase noise can be dependent on a type of UE. In one illustrative example, a high-tier UE can measure phase with a higher bit depth or higher quantization (e.g., 8 bits) and a lower-tier UE can measure with a lower bit depth (e.g., 4 bits). The lower-tier UE will introduce more phase noise based on the lower accuracy of the lower bit depth in this example. An example measurement capability report is illustrated in Table 1 and identifies various parameters of a downlink measurement capability report and a corresponding type of data for that parameter.

TABLE 1
{
NR-DL-MeasCapability ::= SEQUENCE {

| ue-SSID-r16 | NR-UE-SSID (0..255), | |
|---|---|---|
| nr-PhysCellID-r16 | NR-PhysCellID-r16 | OPTIONAL, |
| nr-CellGlobalID-r16 | NCGI-r15 | OPTIONAL, |
| nr-ARFCN-r16 | ARFCN-ValueNR-r15 | OPTIONAL, |
| nr-DL-PRS-ResourceID-r16 | NR-DL-PRS-ResourceID-r16 | OPTIONAL, |
| nr-DL-PRS-ResourceSetID-r16 | NR-DL-PRS-ResourceSetID-r16 | OPTIONAL, |
| nr-TimeStamp-r16 | NR-TimeStamp-r16, | |
| ue-PhaseMeasurementCapability | INTEGER (0..16) | |
| ue-PhaseIfftWindowSize | INTEGER (0..4) | |
| ue-PhaseNoiseFloor | INTEGER (0..16) | |
| nr-TimingQuality-r16 | NR-TimingQuality-r16, | |
| nr-DL-PRS-RSRP-Result-r16 | INTEGER (0..126) | OPTIONAL, |

| | |
|---|---|
| nr-DL-TDOA-AdditionalMeas | NR-DL-TDOA-AdditionalMeasurements-r16 |

...
}

According to an illustrative example, the UE phase measurement capability report may identify a resolution of an ADC (e.g., ue-PhaseMeasurementCapability) that measures the phase, an IFFT window size, and a phase noise floor. The phase noise floor can be measured at the UE because sensitivity of the receiver is affected by many different environmental factors such as temperature, multipath fading, power consumption, and other parasitic effects, and may be reported to the LMF 606. In some cases, the UE can report the various parameters in different units, such as radians, degrees, a power such as decibels per milliwatt (dBm), or an integer that maps to another value. The measurement capability report in Table 1 is one example and other implementations are possible with less information or additional parameters for a network entity's consideration.

The LMF 606 can receive the phase measurement capability report 608, determine measurement parameters for the UE 602 (at block 610) based on the phase measurement capability report 608, and transmit a measurement request including the measurement parameters to the UE 602. In some aspects, the LMF 606 can use an existing measurement request 612, such as a downlink time difference of arrival (TDoA) measurement element, and include the phase measurement information in reserved portions of the element. For example, Table 2 is an example of a measurement request 612 (e.g., a TDoA downlink measurement element) that includes a phase measurement step size for the UE 602 to select. In some aspects, the TDoA downlink measurement element includes a list of a phase measurement step sizes that the UE 602 selects based on the phase measurement capability report 608. When the UE 602 receives the element, the UE 602 can select step sizes f0, f1, f3, and f4 for a carrier phase measurement. In some aspects, the UE 602 can select a size for different carrier phase measurements (e.g., f0 for subcarrier pairs that have a large equivalent wavelength, and f4 for subcarrier pairs that have a short equivalent wavelength).

TABLE 2
NR-DL-TDOA-MeasElement-r16 ::= SEQUENCE {

| | | |
|---|---|---|
| dl-PRS-ID-r16 | INTEGER (0..255), | |
| nr-PhysCellID-r16 | NR-PhysCellID-r16 | OPTIONAL, |
| nr-CellGlobalID-r16 | NCGI-r15 | OPTIONAL, |
| nr-ARFCN-r16 | ARFCN-ValueNR-r15 | OPTIONAL, |
| nr-DL-PRS-ResourceID-r16 | NR-DL-PRS-ResourceID-r16 | OPTIONAL, |
| nr-DL-PRS-ResourceSetID-r16 | NR-DL-PRS-ResourceSetID-r16 | OPTIONAL, |

| | |
|---|---|
| nr-TimeStamp-r16 | NR-TimeStamp-r16, |
| nr-RSTD-r16 | CHOICE { |
| k0-r16 | INTEGER (0..1970049), |
| k1-r16 | INTEGER (0..985025), |
| k2-r16 | INTEGER (0..492513), |
| k3-r16 | INTEGER (0..246257), |
| k4-r16 | INTEGER (0..123129), |
| k5-r16 | INTEGER (0..61565), |

...
},

| nr-AdditionalPathList-r16 | NR-AdditionalPathList-r16 | OPTIONAL, |
|---|---|---|
| nr-TimingQuality-r16 | NR-TimingQuality-r16, | |
| nr-DL-PRS-RSRP-Result-r16 | INTEGER (0..126) | OPTIONAL, |

| | |
|---|---|
| nr-DL-TDOA-AdditionalMeas | NR-DL-TDOA-AdditionalMeasurements-r16, |
| nr-PhaseMeasurementStepSize | CHOICE { |
| f0 | INTEGER (0 ... 31), |
| f1 | INTEGER (0 ... 255), |
| f2 | INTEGER (0 ... 1023), |
| f3 | INTEGER (0...4095) |

},

| | |
|---|---|
| nr-PhaseMeasurementCarriers | CHOICE { |

...
},

| | |
|---|---|
| nr-PhaseMinSubcarrierPair | INTEGER (0..127), |
| nr-PhaseMaxSubcarrierPair | INTEGER (0..1023), |

...

At block 614, the UE 602 can determine measurements based on the measurement request 612. The measurements can include a number of parameters such as quantity of subcarrier pairs to measure, an equivalent wavelength of the subcarrier pair, and a measurement step size. In some aspects, the UE 602 may need to measure multiple phase measurements to provide sufficient information for the positioning calculations. For example, a narrow subcarrier group, while having a large equivalent distance (and a large measurable range) will not be as accurate due to phase noise and measurement step size. Additional measurements can be combined with the narrow subcarrier group to iteratively improve the accuracy. In some aspects, a measurement of a subcarrier of the subcarrier pair may experience adverse effects such as multipath fading, and the resulting measurement may be deemed invalid based on the multipath fading.

In some aspects, the UE 602 may be configured to determine various parameters related to equivalent wavelengths. For example, based on a phase step size, the UE 602 may determine that a minimum subcarrier pair distance, for example the difference in the subcarrier indexes. In some aspects, the UE 602 may determine that a maximum subcarrier pair distance. The UE 602 can report the distances in various units such as, for example, a wavelength, a frequency.

After determining the phase measurements, the UE 602 can measure reference signals 616 that are transmitted by the TRP 604 at a first time. In some aspects, the UE 602 may need to perform additional measurements based on different factors such as UE capability. For example, if the UE 602 is capable of measuring a maximum of 3 subcarrier pairs in a particular time period and the UE determines that 6 subcarrier pairs will be measured, the UE will need to perform measurements at a different time. The UE 602 can therefore measure the reference signals 618 at a second time. In some cases, the UE 602 can also perform another positioning process at block 620, such as a TDoA.

At block 620, the UE 602 generates a phase measurement report 622 that includes the results of the phase measurements and transmits the phase measurement report 622 to the LMF 606. Table 3 below identifies an example of a phase measurement report 622 that includes various parameters that the UE 602 may include. In the example in Table 3, the UE 602 can include up to 8 phase measurements, and the phase measurement can implement an interface defined NR-PhaseMeasurements in Table 3 that includes an identifier for the lower subcarrier, an identifier of the higher subcarrier, a phase difference of the subcarriers (e.g., Δφ), a phase step size, and a measurement time stamp, which can be mapped to a symbol in the time domain.

TABLE 3
NR-DL-TDOA-MeasReport-r16 ::= SEQUENCE {

| dl-PRS-ID-r16 | INTEGER (0..255), | |
|---|---|---|
| nr-PhysCellID-r16 | NR-PhysCellID-r16 | OPTIONAL, |
| nr-CellGlobalID-r16 | NCGI-r15 | OPTIONAL, |
| nr-ARFCN-r16 | ARFCN-ValueNR-r15 | OPTIONAL, |
| nr-DL-PRS-ResourceID-r16 | NR-DL-PRS-ResourceID-r16 | OPTIONAL, |
| nr-DL-PRS-ResourceSetID-r16 | NR-DL-PRS-ResourceSetID-r16 | OPTIONAL, |

| | |
|---|---|
| nr-MeasTimeStamp-r16 | NR-TimeStamp-r16, |
| nr-MeasTimeStepSize | INTEGER (0 .. 10) |
| nr-RSTD-r16 | CHOICE { |
| k0-r16 | INTEGER (0..1970049), |
| k1-r16 | INTEGER (0..985025), |
| k2-r16 | INTEGER (0..492513), |
| k3-r16 | INTEGER (0..246257), |
| k4-r16 | INTEGER (0..123129), |
| k5-r16 | INTEGER (0..61565), |

...
},

| | |
|---|---|
| nr-PhaseMeasurement | NR-PhaseMeasurements[0..7] { |
| nr-LowerSubcarrier | INTEGER (0 ... 3263), |
| nr-HigherSubcarrier | INTEGER (0 ... 3263), |
| nr-DeltaPhase | INTEGER (0 ... 4096), |
| nr-PhaseStepSize | INTEGER (0 ... 32), |
| nr- MeasTimeStamp | NR-TimeStamp-r16, |

},

| | |
|---|---|
| nr-PhaseMeasurementCapacity | INTEGER (0..128), |
| nr-PhaseDefaultStepSize | INTEGER (0..32), |
| nr-PhaseMinimumStepSize | INTEGER (0..32), |

...

The example phase measurement report 622 in Table 3 also includes a phase measurement capacity that identifies a number of phase measurements that the UE 602 is capable of performing based on a current buffer capacity. In some aspects, carrier phase measurements can be stored in a buffer and may not have been processed before the phase measurement report 622 was transmitted. The UE 602 can therefore identify a number of phase measurements that the UE 602 is capable of processing, or a number of phase measurements that the UE 602 has not yet reported. In some aspects, the phase measurement report 622 can also include a default measurement step size that identifies a default step size. In some cases, a phase measurement report of a subcarrier pair may not expressly identify the measurement step size, which indicates the phase measurement report used the default step size. In other aspects, subcarrier pairs can be grouped based on a distance of the equivalent wavelength, and a specific measurement step size can be applied to all subcarrier measurements of a particular group. In some cases, the LMF 606 can identify a minimum phase step size. The minimum step size can be based on various aspects such as transmission range of the TRP 604. In the case of a minimum phase step size, the UE 602 can select any measurement that has greater accuracy. In some cases, the minimum phase step size can affect some parameters such as minimum subcarrier distance for some types of measurements.

In some aspects, the values of the phase measurements can be reported in a variety of manners. For example, a measurement step size can be represented as an integer that is mapped to a phase value, which can be either linear or non-linear in step size, a frequency, a wavelength, a subcarrier different, for example.

The phase measurement report 622 may also include other measurements to facilitate any positioning techniques. In one illustrative example, the phase measurement report 622 can include a time domain step size (e.g., nr-MeasTimeStepSize) that corresponds to the accuracy of time domain measurements used in, for example, ToA positioning techniques.

The LMF 606 receives the phase measurement report 622 and determines (at block 624) a location of the UE 602 using various information. In some aspects, the LMF 606 may be able to use the measured phase information to identify a precise location of the UE 602. In other aspects, the LMF 606 can use both positioning techniques (e.g., TDoA and phase positioning) to determine a precise location or may use one positioning technique to refine or verify the location of the UE 602.

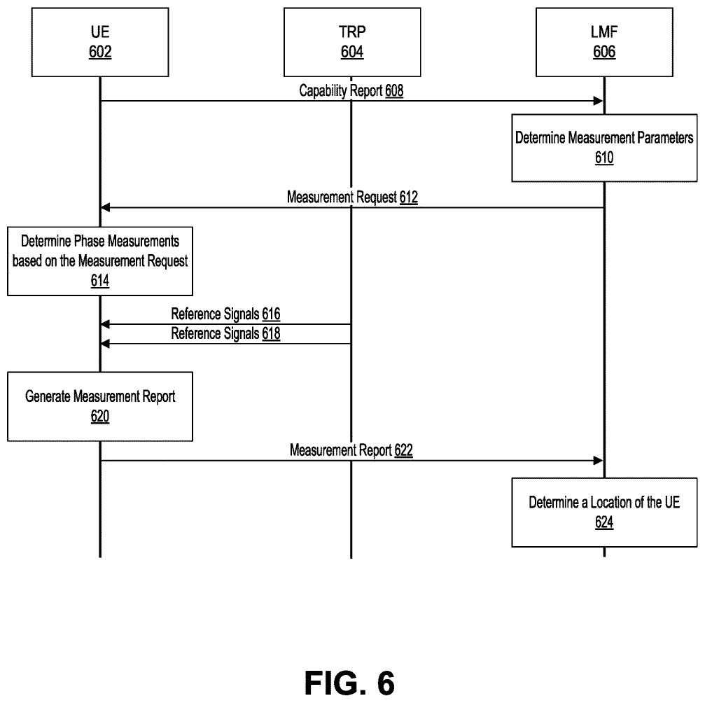

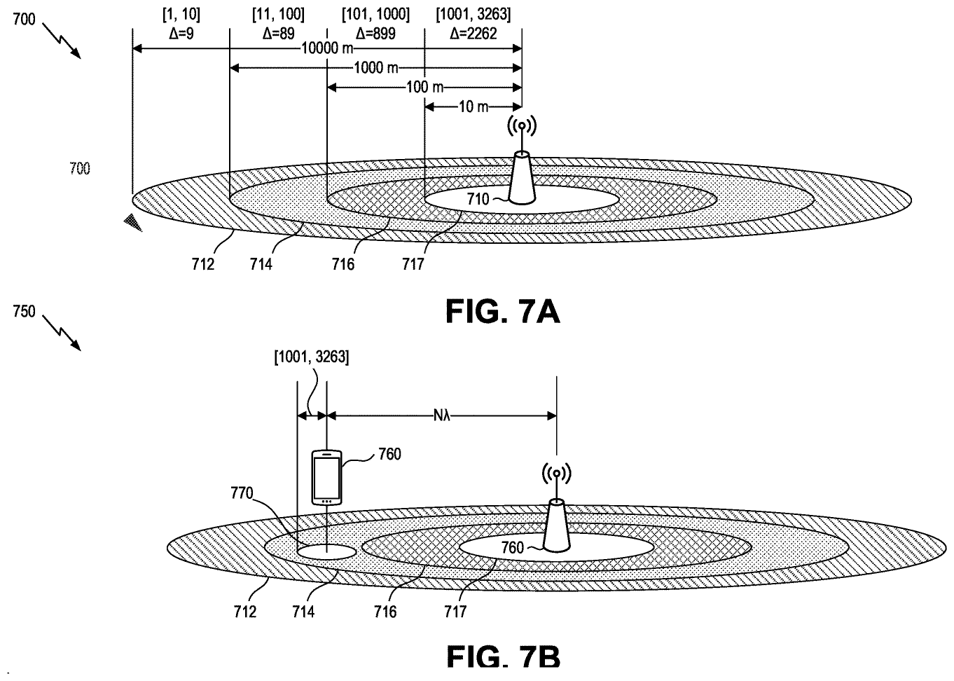

FIG. 7A is an illustration of wireless communication system 700 and different subcarrier pair configurations for measuring phase and determining a location from a transmitting device, according to some aspects of the present disclosure. As noted above, subcarriers can be grouped for various purposes. In some aspects, a TRP 710 is configured to transmit a reference signal (e.g., PRS, TRS, PTRS, CRS, DMRS, CSI-RS, SRS, PSS, SSS, and SSB) using different subcarriers and the reference signals can be transmitted in a pattern such as a comb structure. In some aspects, the TRP 710 can group different subcarrier pair configuration based on a difference (or a distance) of the subcarrier indexes.

The TRP 710 in this example has created a narrow subcarrier pair configuration 712 having a lower subcarrier boundary of 1 and an upper subcarrier boundary of 10, or a maximum difference of 9. In this case, the subcarriers in this group will have a minimum equivalent distance of approximately 1,000 m and a maximum equivalent distance of approximately 10,000 m. The subcarrier pair configuration 714 has a minimum equivalent distance of approximately 100 m and a maximum equivalent distance of approximately 1,000 m. The subcarrier pair configuration 716 has a minimum equivalent distance of approximately 10 m and a maximum equivalent distance of approximately 1,000 m. The subcarrier pair configuration 717 has a minimum equivalent distance of approximately 3 m based on the widest configuration noted above and a maximum equivalent distance of approximately 10 m.

FIG. 7B is an illustration of wireless communication system 750 and combining phase measurements of different subcarrier pair configurations to improve determining a location from a transmitting device. In some aspects, measurements provided by different subcarrier pair configurations can be combined to more accurately determine a location within a region 770. In the wireless communication system 750, the UE 760 is positioned within a region associated with either the subcarrier pair configuration 712 or the subcarrier pair configuration 714. The LMF can instruct the UE 760 to perform various measurements using any of the subcarrier pair configurations. For example, the LMF can determine that distances to the UE 760 determined using the subcarrier pair configuration 712 or the subcarrier pair configuration 714 at least partially overlap and the LMF may identify an approximate distance to the UE 760 based on the accuracy of the subcarrier pair configuration 714. In some aspects, the LMF can also combine the phase measurement with other distance estimation techniques such as RSTD, TDoA, etc.

The LMF may transmit a measurement report to the UE 760 that indicates an estimated distance from the TRP 710 and the UE 760 can determine a number of cycles associated with each subcarrier of a wider subcarrier configuration pair. The UE 760 can measure the phase difference of the wider subcarrier configuration pair and the UE 760 or LMF can determine a location of the UE 760 within region 770 because the number of cycles is not unknown. For example, the UE 760 or LMF could identify the number of cycles (e.g., Nₖ and Nₖ₋ₘ) for a subcarrier pair of a wider subcarrier configuration (e.g., having a shorter equivalent wavelength) and then determine the distance using Equation 8. Based on the shorter equivalent wavelength of the wider subcarrier pair, the UE or the LMF can identify a more precise location within the region 770. In this case, the different measurements could be simultaneous or sequential.

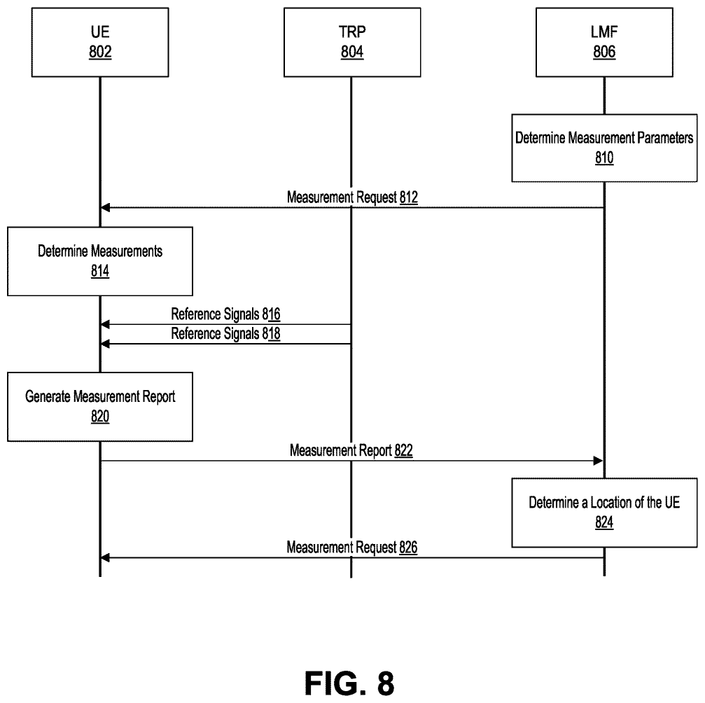

FIG. 8 is a sequence diagram of another process for configuring phase measurements in a wireless communication system, according to some aspects. In some aspects, the wireless communication system includes a UE 802, a TRP 804 configured to transmit reference signals for the UE 802, and an LMF 806 for determining a position or a location of the UE 802. In some examples, the UE 802 may know the characteristics of the reference signal and can compare the received signal with the known characteristics to determine various information such as path loss, time, etc. Non-limiting examples of reference signals that the TRP 804 can transmit and the UE 802 can measure include PRS, TRS, PTRS, CRS, DMRS, CSI-RS, SRS, PSS, SSS, and SSB.

In the process illustrated by FIG. 8, the UE 802 may not transmit a carrier capability report to the LMF 806. The LMF 806, at block 810, determines measurement parameters related to various subcarrier pair combinations for the UE 802 to measure. In one illustrative example, the measurement parameters may exclude various information illustrated above in Table 2, such as a phase measurement step size.

The LMF 806 may transmit a measurement request 812 to the UE 802, which determines measurements to perform at block 814. In some aspects, the UE 802 may determine various parameters related to the phase measurement such as the measurement step size.

In some aspects, measurement step sizes may be defined and the UE 802 may need to comport with reporting a defined step size. In this case, the UE 802 can use information related to the TRP 804 to determine phase measurement information, such as which subcarrier pairs to prefer, and the measurement step size. For example, if the UE 802 determines that the received signal strength indicator (RSSI) of the TRP 804 is above a particular power level, the UE 802 can determine shorter equivalent wavelengths (e.g., narrow subcarrier pairs or narrow lanes) may be preferred and a step size. In some cases, the measurement step size can be based on a confidence to reduce overhead (e.g., power consumption) of the UE. As noted above with reference to FIG. 6, the UE can measure reference signals 816 at a first time and reference signals 818 at a second time.

The UE 802 at block 820 can generate a measurement report 822 that identifies various parameters, including parameters determined by the UE 802, and transmit the measurement report 822 to the LMF 806. In response, the LMF 806 can determine a location of the UE at block 824. In some aspects, the LMF 806 can determine that the location of the UE does not comport with a particular function requested by the UE and further measurements are necessary. Accordingly, the LMF 806 can generate a measurement request 826 based on the current location of the UE 802 and transmit the measurement request 826 to the UE 802.

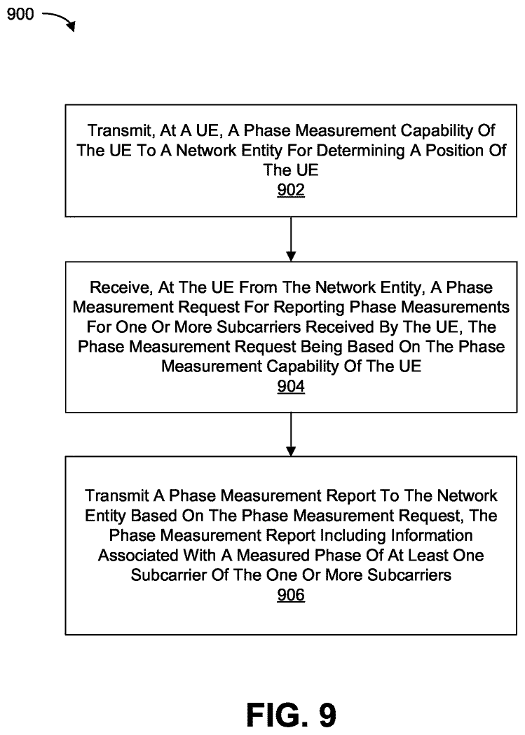

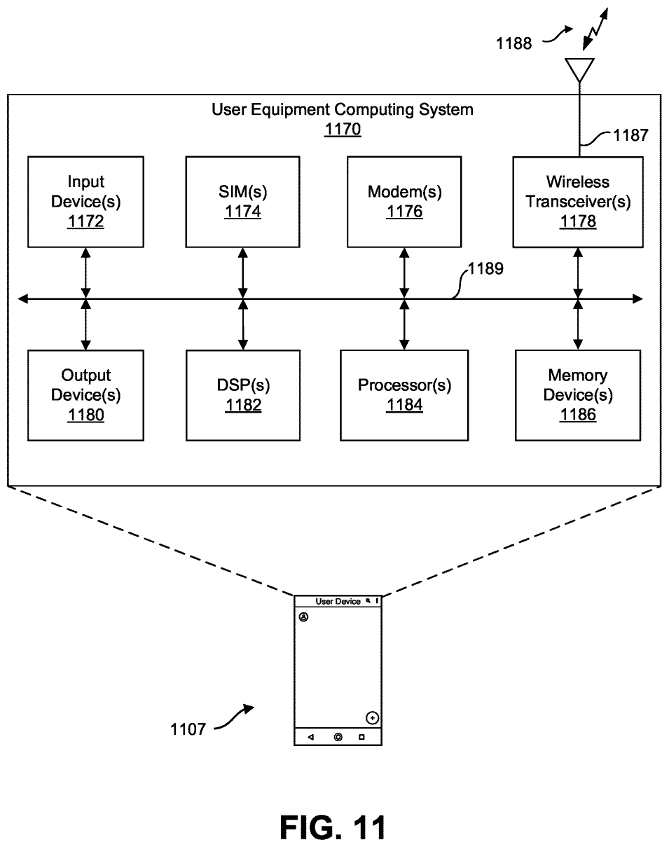

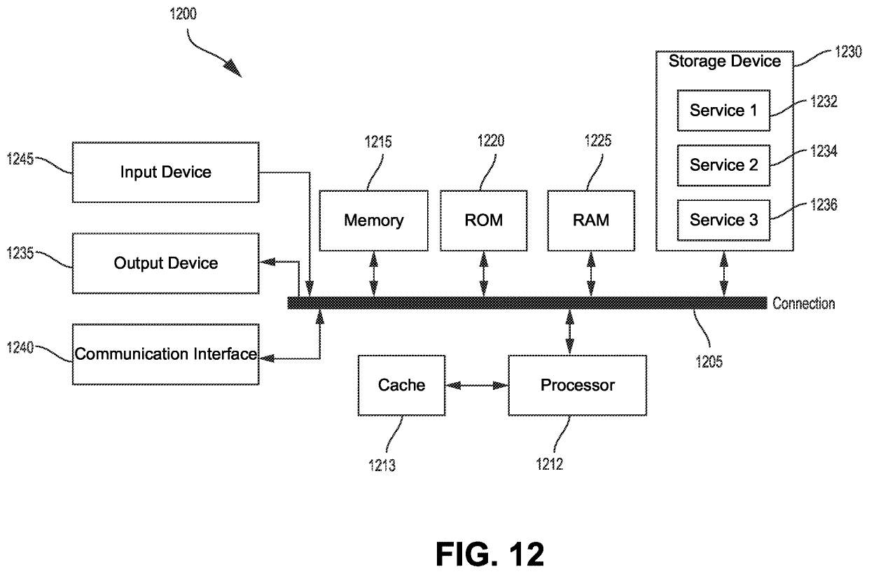

FIG. 9 is a flow chart illustrating an example of a process 900 for wireless communications. For instance, the process 900 can be used for estimating distances to a UE, according to the systems and techniques described herein. The process 900 can be performed by a computing device or apparatus, such as a wireless communications device (e.g., a UE), or a component or system (e.g., a chipset) of the wireless communication device. The operations of the process 900 may be implemented as software components that are executed and run on one or more processors (e.g., processor(s) 1184 of FIG. 11, processor 1212 of FIG. 12, or other processor(s)). Further, the transmission and reception of signals by the wireless communications device in the process 900 may be enabled, for example, by one or more antennas (e.g., antenna 1187 of FIG. 11) and/or one or more transceivers (e.g., wireless transceiver(s) 1178 of FIG. 11).

At block 902, the computing device (or component thereof) transmits a phase measurement capability of the UE to a network entity for determining a position of the UE. For instance, the phase measurement capability may include a minimum phase measurement capability of the UE.

At block 904, the computing device (or component thereof) receives, from the network entity, a phase measurement request for reporting phase measurements for one or more subcarriers received by the UE. For example, the phase measurement request reporting of phase measurements for a single subcarrier, multiple subcarriers, a subcarrier pair (e.g., measured phase differences), or a subcarrier set or subcarrier set pair. In such cases, the request may include information requesting that the UE report the phase of single subcarrier, the phases of a subcarrier set, or the phase difference(s) between subcarrier pairs or subcarrier set pairs. As described above, a subcarrier set includes at least one subcarrier. For instance, as noted above, one example of a “set of subcarriers” is a set with a single subcarrier. In such cases, a pair of subcarriers includes two subcarriers (as each set would include a single subcarrier). In some examples, “X subcarriers” (e.g., consecutive subcarriers) can be included in a set of subcarriers, in which case the wireless communication device can derive a single phase measurement for the set of subcarriers including X subcarriers. The measurement report can include the measured phase difference(s) between the at least one subcarrier set pair or can include the measured phases (in which case the first network entity or other network entity can determine the phase difference(s)).

In some cases, the phase measurement request may be based on the phase measurement capability of the UE. For example, the phase measurement request can include a step size associated with a plurality of phase measurements for a plurality of subcarrier pairs. In another example, the phase measurement capability includes information associated with an ability of the UE to measure a phase difference between a maximum subcarrier pair, information associated with a capability of the UE may include at least one of a wavelength associated with the maximum subcarrier pair, a frequency associated with the maximum subcarrier pair, a subcarrier difference associated with the maximum subcarrier pair, any combination thereof, and/or other capability. In some aspects, the phase measurement capability can include information associated with a capability of the UE to measure a phase difference between a minimum subcarrier pair, or the phase measurement capability can include information associated with an ability of the UE to report measurements on a maximum number of subcarrier pairs. The phase measurement capability may also include information associated with an ability of the UE to resolve minimum phase ambiguity.

The phase measurement request may include a respective step size for each subcarrier pair of a plurality of subcarrier pairs. In this case, the UE may select a respective step size for each subcarrier pair of the plurality of subcarrier pairs based on the respective step size included in the phase measurement request.

In some cases, the computing device (or component thereof) may select a step size for the at least one subcarrier pair, with the step size being selected based on a quality of the measured phase difference. In other aspects, the computing device (or component thereof) may select different step sizes for measuring phase differences between respective subcarrier pairs of different reference signal resources. The computing device (or component thereof), in some cases, may select different step sizes for measuring phase differences between different subcarrier pairs based on a type of resource associated with the different subcarrier pairs. In other cases, the computing device (or component thereof) may receive a step size for the at least one subcarrier pair, which is determined by the network entity.

The computing device (or component thereof) may, based on the phase measurement request, select a respective step size from a plurality of step sizes for each subcarrier or subcarrier pair of the plurality of subcarriers or subcarriers pairs based at least on the reported phase measurement capability. The respective step size for each subcarrier pair is selected based on an overhead associated with measuring of a phase difference for each subcarrier pair. In some aspects, the computing device may select a respective step size from a plurality of step sizes for each subcarrier or subcarrier pair of the plurality of subcarriers or subcarriers pairs based at least on the step size included in the phase measurement request

The computing device (or component thereof) may measure, based on the phase measurement request, the phase difference between the at least one subcarrier pair of the one or more subcarrier pairs. In some cases, the measurements can be different, have a different measurement step size, and so forth.

At block 906, the computing device (or component thereof) transmits a phase measurement report to the network entity based on the phase measurement request. The phase measurement report can include information associated with a measured phase of at least one subcarrier of the one or more subcarriers. The measurement report can be configured based on the various aspects measurements and, for example can includes the measured phase difference and an associated step size.

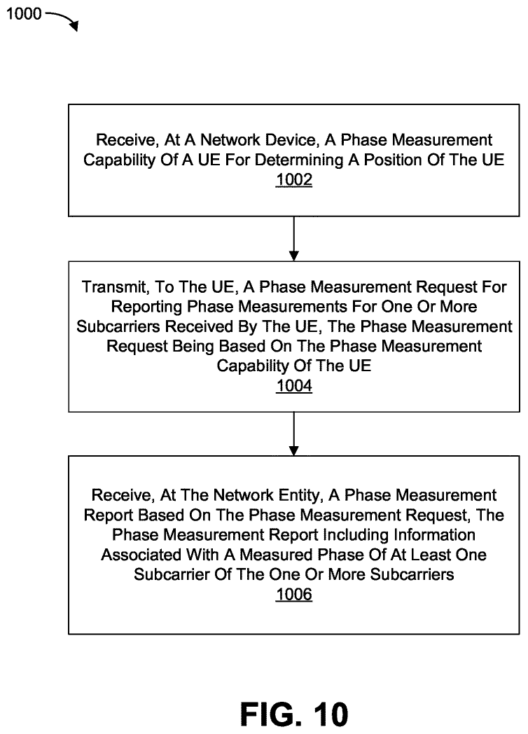

FIG. 10 is a flow chart illustrating an example of a process 1000 for wireless communications. For instance, the process 1000 can be used for estimating distances to a UE, according to the systems and techniques described herein. The process 1000 can be performed by a network entity (e.g., an eNB, a gNB, a location server such as an LMF, or a portion thereof, such as one or more of a CU, a DU, a RU, a Near-RT RIC, or a Non-RT RIC.) or by a component or system (e.g., a chipset) of the network entity. The operations of the process 1000 may be implemented as software components that are executed and run on one or more processors (e.g., processor 1212 of FIG. 12 or other processor(s)). Further, the transmission and reception of signals by the wireless communications device in the process 1000 may be enabled, for example, by one or more antennas and/or one or more transceivers (e.g., wireless transceiver(s)).

At block 1002, the network entity (or component thereof) receives a phase measurement capability of a device (e.g., a user equipment (UE), a gNB, etc.) for determining a position of the device. The phase measurement capability includes at least one of a minimum phase measurement capability of the device. In some examples, the phase measurement capability includes information associated with an ability of the UE to measure a phase difference between a maximum subcarrier pair. the phase measurement capability includes information associated with a capability of the UE to measure a phase difference between a minimum subcarrier pair.

At block 1004, the network entity (or component thereof) transmits, to the device, a phase measurement request for reporting phase measurements for one or more pairs of subcarriers received by the UE. As described above, the phase measurement request may be on the phase measurement capability of the UE. The phase measurement request may include a step size associated with a plurality of phase measurements for a plurality of subcarrier pairs. In some cases, the phase measurement request includes a respective step size for each subcarrier pair of a plurality of subcarrier pairs. In other cases, the network entity may provide a fixed value for a measurement step size.

At block 1006, the network entity (or component thereof) receives a phase measurement report based on the phase measurement request. As described above, the phase measurement report may include information associated with a measured phase difference between at least one subcarrier pair of the one or more subcarrier pairs. In some cases, the phase measurement report can include the measured phase difference and an associated step size.

FIG. 11 illustrates an example of a computing system 1170 of a UE 1107. In some examples, the UE 1107 can include a mobile phone, router, tablet computer, laptop computer, tracking device, wearable device (e.g., a smart watch, glasses, an XR device, etc.), IoT device, and/or other device used by a user to communicate over a wireless communications network. The computing system 1170 includes software and hardware components that can be electrically coupled via a bus 1189 (or may otherwise be in communication, as appropriate). For example, the computing system 1170 includes one or more processors 1184. The one or more processors 1184 can include one or more CPUs, ASICs, FPGAs, APs, GPUs, VPUs, NSPs, microcontrollers, dedicated hardware, any combination thereof, and/or other processing device or system. The bus 1189 can be used by the one or more processors 1184 to communicate between cores and/or with the one or more memory devices 1186.

The computing system 1170 may also include one or more memory devices 1186, one or more digital signal processors (DSPs) 1182, one or more subscriber identity modules (SIMs) 1174, one or more modems 1176, one or more wireless transceivers 1178, an antenna 1187, one or more input devices 1172 (e.g., a camera, a mouse, a keyboard, a touch sensitive screen, a touch pad, a keypad, a microphone, and/or the like), and one or more output devices 1180 (e.g., a display, a speaker, a printer, and/or the like). As used herein, the one or more wireless transceivers 1178 can include one or more receiving devices (e.g., receivers) and/or one or more transmitting devices (e.g., transmitters).

The one or more wireless transceivers 1178 can transmit and receive wireless signals (e.g., signal 1188) via antenna 1187 to and from one or more other devices, such as one or more other UEs, network devices (e.g., base stations such as eNBs and/or gNBs, WiFi routers, etc.), cloud networks, and/or the like. As described herein, the one or more wireless transceivers 1178 can include a combined transmitter/receiver, discrete transmitters, discrete receivers, or any combination thereof. In some examples, the computing system 1170 can include multiple antennae. The wireless signal 1188 may be transmitted via a wireless network. The wireless network may be any wireless network, such as a cellular or telecommunications network (e.g., 3G, 4G, 5G, etc.), wireless local area network (e.g., a WiFi network), a Bluetooth™ network, and/or other network. In some examples, the one or more wireless transceivers 1178 may include a RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end can generally handle selection and conversion of the wireless signals 1188 into a baseband or intermediate frequency and can convert the RF signals to the digital domain.

In some cases, the computing system 1170 can include a coding-decoding device (or CODEC) configured to encode and/or decode data transmitted and/or received using the one or more wireless transceivers 1178. In some cases, the computing system 1170 can include an encryption-decryption device or component configured to encrypt and/or decrypt data (e.g., according to the AES and/or DES standard) transmitted and/or received by the one or more wireless transceivers 1178.

The one or more SIMs 1174 can each securely store an International Mobile Subscriber Identity (IMSI) number and a related key assigned to the user of the UE 1107. The IMSI and the key can be used to identify and authenticate the subscriber when accessing a network provided by a network service provider or operator associated with the one or more SIMs 1174. The one or more modems 1176 can modulate one or more signals to encode information for transmission using the one or more wireless transceivers 1178. The one or more modems 1176 can also demodulate signals received by the one or more wireless transceivers 1178 in order to decode the transmitted information. In some examples, the one or more modems 1176 can include a 4G (or LTE) modem, a 5G (or NR) modem, a Bluetooth™ modem, a modem configured for vehicle-to-everything (V2X) communications, and/or other types of modems. In some examples, the one or more modems 1176 and the one or more wireless transceivers 1178 can be used for communicating data for the one or more SIMs 1174.

The computing system 1170 can also include (and/or be in communication with) one or more non-transitory machine-readable storage media or storage devices (e.g., one or more memory devices 1186), which can include, without limitation, local and/or network accessible storage, a disk drive, a drive array, an optical storage device, a solid-state storage device such as a RAM and/or a ROM, which can be programmable, flash-updateable and/or the like. Such storage devices may be configured to implement any appropriate data storage, including without limitation, various file systems, database structures, and/or the like.

In various aspects, functions may be stored as one or more computer-program products (e.g., instructions or code) in memory device(s) 1186 and executed by the one or more processor(s) 1184 and/or the one or more DSPs 1182. The computing system 1170 can also include software elements (e.g., located within the one or more memory devices 1186), including, for example, an operating system, device drivers, executable libraries, and/or other code, such as one or more application programs, which may comprise computer programs implementing the functions provided by various aspects, and/or may be designed to implement methods and/or configure systems, as described herein.

In some aspects, the UE 1107 can include means for performing operations described herein. The means can include one or more of the components of the computing system 1170. For example, the means for performing operations described herein may include one or more of input device(s) 1172, SIM(s) 1174, modems(s) 1176, wireless transceiver(s) 1178, output device(s) 1180, DSP(s) 1182, processors 1184, memory device(s) 1186, and/or antenna(s) 1187.

In some aspects, the UE 1107 can include means for receiving resource configuration information, wherein the resource configuration information is based on a threshold associated with the apparatus, and wherein the resource configuration information indicates a time-gap for transmission of SRS resources. In some aspects, the UE 1107 may further include means for transmitting one or more SRS resources based on the time-gap indicated by the resource configuration information.

In some examples, the means for receiving can include the one or more wireless transceivers 1178, the one or more modems 1176, the one or more SIMs 1174, the one or more processors 1184, the one or more DSPs 1182, the one or more memory devices 1186, any combination thereof, or other component(s) of the client device. In some examples, the means for determining can include the one or more processors 1184, the one or more DSPs 1182, the one or more memory devices 1186, any combination thereof, or other component(s) of the client device. In some examples, the means for transmitting can include the one or more wireless transceivers 1178, the one or more modems 1176, the one or more SIMs 1174, the one or more processors 1184, the one or more DSPs 1182, the one or more memory devices 1186, any combination thereof, or other component(s) of the client device.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces can be configured to communicate and/or receive wired and/or wireless data, including data according to the 3G, 4G, 5G, and/or other cellular standard, data according to the Wi-Fi (802.11x) standards, data according to the Bluetooth™ standard, data according to the IP standard, and/or other types of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), DSPs, central processing units (CPUs), and/or other suitable electronic circuits), and/or can include and/or be implemented using computer software, firmware, or any combination thereof, to perform the various operations described herein.

FIG. 12 is a diagram illustrating an example of a system for implementing certain aspects of the present technology. In particular, FIG. 12 illustrates an example of computing system 1200, which can be for example any computing device making up internal computing system, a remote computing system, a camera, or any component thereof in which the components of the system are in communication with each other using connection 1205. Connection 1205 can be a physical connection using a bus, or a direct connection into processor 1210, such as in a chipset architecture. Connection 1205 can also be a virtual connection, networked connection, or logical connection.

In some aspects, computing system 1200 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1200 includes at least one processing unit (CPU or processor) 1210 and connection 1205 that couples various system components including system memory 1215, such as read-only memory (ROM) 1220 and random-access memory (RAM) 1225 to processor 1210. Computing system 1200 can include a cache 1213 of high-speed memory connected directly with, in close proximity to, or integrated as part of processor 1210.

Processor 1210 can include any general-purpose processor and a hardware service or software service, such as services 1232, 1234, and 1236 stored in storage device 1230, configured to control processor 1210 as well as a special-purpose processor where software instructions are incorporated into the actual processor design. Processor 1210 may essentially be a completely self-contained computing system, containing multiple cores or processors, a bus, memory controller, cache, etc. A multi-core processor may be symmetric or asymmetric.

To enable user interaction, computing system 1200 includes an input device 1245, which can represent any number of input mechanisms, such as a microphone for speech, a touch-sensitive screen for gesture or graphical input, keyboard, mouse, motion input, speech, etc. Computing system 1200 can also include output device 1235, which can be one or more of a number of output mechanisms. In some instances, multimodal systems can enable a user to provide multiple types of input/output to communicate with computing system 1200. Computing system 1200 can include communications interface 1240, which can generally govern and manage the user input and system output.

The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, DSRC wireless signal transfer, 802.11 Wi-Fi wireless signal transfer, WLAN signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/long term evolution (LTE) cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1240 may also include one or more GNSS receivers or transceivers that are used to determine a location of the computing system 1200 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1230 can be anon-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a Europay, Mastercard and Visa (EMV) chip, a subscriber identity module (SIM) card, a mini/micro/nano/pico SIM card, another integrated circuit (IC) chip/card, RAM, static RAM (SRAM), dynamic RAM (DRAM), ROM, programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 1230 can include software services, servers, services, etc., that when the code that defines such software is executed by the processor 1210, it causes the system to perform a function. In some aspects, a hardware service that performs a particular function can include the software component stored in a computer-readable medium in connection with the necessary hardware components, such as processor 1210, connection 1205, output device 1235, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections.

As used herein the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but may have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as RAM such as synchronous dynamic random access memory (SDRAM), ROM, non-volatile random access memory (NVRAM), EEPROM, flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more DSPs, general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1: A method for wireless communications at a user equipment (UE), comprising: transmitting, at the UE, a phase measurement capability of the UE to a network entity for determining a position of the UE; receiving, at the UE from the network entity, a phase measurement request for reporting phase measurements for one or more subcarriers received by the UE, the phase measurement request being based on the phase measurement capability of the UE; and transmitting a phase measurement report to the network entity based on the phase measurement request, the phase measurement report including information associated with a measured phase of at least one subcarrier of the one or more subcarriers.

Aspect 2: The method of Aspect 1, further comprising: measuring, at the UE based on the phase measurement request, a phase of the at least one subcarrier of the one or more subcarriers.

Aspect 3: The method of any of Aspects 1 to 2, wherein the phase measurement request includes a step size associated with a plurality of phase measurements for a plurality of subcarrier pairs.

Aspect 4: The method of any of Aspects 1 to 3, further comprising: selecting a respective step size from a plurality of step sizes for each subcarrier or subcarrier pair of the plurality of subcarriers or subcarrier pairs based at least on the phase measurement capability.

Aspect 5: The method of any of Aspects 1 to 4, wherein the respective step size for each subcarrier pair is selected based on an overhead associated with measuring of a phase difference for each subcarrier pair.

Aspect 6: The method of any of Aspects 1 to 5, selecting a respective step size from a plurality of step sizes for each subcarrier or subcarrier pair of the plurality of subcarriers or subcarrier pairs based at least on the step size included in the phase measurement request.

Aspect 7: The method of any of Aspects 1 to 6, wherein the phase measurement request includes a respective step size for each subcarrier pair of a plurality of subcarrier pairs.

Aspect 8: The method of any of Aspects 1 to 7, further comprising: selecting a respective step size for each subcarrier pair of the plurality of subcarrier pairs based on the respective step size included in the phase measurement request.

Aspect 9: The method of any of Aspects 1 to 8, wherein the phase measurement report includes a measured phase difference between at least one subcarrier pair and an associated step size.

Aspect 10: The method of any of Aspects 1 to 9, wherein the phase measurement capability includes a minimum phase measurement capability of the UE.

Aspect 11: The method of any of Aspects 1 to 10, further comprising: selecting, at the UE, a step size for at least one subcarrier pair.

Aspect 12: The method of any of Aspects 1 to 11, wherein the step size is selected from a predefined number of step sizes.

Aspect 13: The method of any of Aspects 1 to 12, wherein the step size is selected based on a quality of a measured phase difference between at least one subcarrier pair.

Aspect 14: The method of any of Aspects 1 to 13, further comprising: selecting, at the UE, different step sizes for measuring phase differences between respective subcarrier pairs of different reference signal resources.

Aspect 15: The method of any of Aspects 1 to 14, further comprising: selecting, at the UE, different step sizes for measuring phase differences between different subcarrier pairs based on a type of resource associated with the different subcarrier pairs.

Aspect 16: The method of any of Aspects 1 to 15, wherein the phase measurement capability includes information associated with an ability of the UE to measure a phase difference between a maximum subcarrier pair.

Aspect 17: The method of any of Aspects 1 to 16, wherein the information includes at least one of a wavelength associated with the maximum subcarrier pair, a frequency associated with the maximum subcarrier pair, or a subcarrier difference associated with the maximum subcarrier pair.

Aspect 18: The method of any of Aspects 1 to 17, wherein the phase measurement capability includes information associated with a capability of the UE to measure a phase difference between a minimum subcarrier pair.

Aspect 19: The method of any of Aspects 1 to 18, wherein the information includes at least one of a wavelength associated with the minimum subcarrier pair, a frequency associated with the minimum subcarrier pair, or a subcarrier difference associated with the minimum subcarrier pair.

Aspect 20: The method of any of Aspects 1 to 19, wherein the phase measurement capability includes information associated with a capability of the UE to report measurements on a maximum number of subcarrier pairs.

Aspect 21: The method of any of Aspects 1 to 20, wherein the phase measurement capability includes information associated with an ability of the UE to resolve minimum phase ambiguity.

Aspect 22: A method for wireless communications at a network entity, comprising: receiving, at the network entity, a phase measurement capability of a user equipment (UE) for determining a position of the UE; transmitting, to the UE, a phase measurement request for reporting phase measurements for one or more subcarriers received by the UE, the phase measurement request being based on the phase measurement capability of the UE; and receiving, at the network entity, a phase measurement report based on the phase measurement request, the phase measurement report including information associated with a measured phase of at least one subcarrier of the one or more subcarriers.

Aspect 23: The method of Aspect 22, wherein the phase measurement request includes a step size associated with a plurality of phase measurements for a plurality of subcarrier pairs.

Aspect 24: The method of any of Aspects 22 to 23, wherein the phase measurement request includes a respective step size for each subcarrier pair of a plurality of subcarrier pairs.

Aspect 25: The method of any of Aspects 22 to 24, wherein the phase measurement report includes a measured phase difference between at least one subcarrier pair and an associated step size.

Aspect 26: The method of any of Aspects 22 to 25, wherein the phase measurement capability includes at least one of a minimum phase measurement capability of the UE.

Aspect 27: The method of any of Aspects 22 to 26, wherein the phase measurement capability includes information associated with a capability of the UE to measure a phase difference between a maximum subcarrier pair.

Aspect 28: The method of any of Aspects 22 to 27, wherein the phase measurement capability includes information associated with a capability of the UE to measure a phase difference between a minimum subcarrier pair.

Aspect 29: An apparatus for wireless communications, comprising: a memory; and one or more processors coupled to the memory, the one or more processors configured to: transmit a phase measurement capability of the apparatus to a network entity for determining a position of the apparatus; receive, from the network entity, a phase measurement request for report phase measurements for one or more subcarriers received by the apparatus, the phase measurement request be based on the phase measurement capability of the apparatus; and transmit a phase measurement report to the network entity based on the phase measurement request, the phase measurement report including information associated with a measured phase of at least one subcarrier of the one or more subcarriers.

Aspect 30: The apparatus of Aspect 29, wherein the one or more processors are configured to: measure, based on the phase measurement request, a phase of the at least one subcarrier of the one or more subcarriers.

Aspect 31: The apparatus of any of Aspects 29 to 30, wherein the phase measurement request includes a step size associated with a plurality of phase measurements for a plurality of subcarrier pairs.

Aspect 32: The apparatus of any of Aspects 29 to 31, wherein the one or more processors are configured to: select a respective step size from a plurality of step sizes for each subcarrier or subcarrier pair of the plurality of subcarriers or subcarrier pairs based at least on the phase measurement capability.

Aspect 33: The apparatus of any of Aspects 29 to 32, wherein the respective step size for each subcarrier pair is selected based on an overhead associated with measuring of a phase difference for each subcarrier pair.

Aspect 34: The apparatus of any of Aspects 29 to 33, wherein the one or more processors are configured to: selecting a respective step size from a plurality of step sizes for each subcarrier or subcarrier pair of the plurality of subcarriers or subcarrier pairs based at least on the step size included in the phase measurement request.

Aspect 35: The apparatus of any of Aspects 29 to 34, wherein the phase measurement request includes a respective step size for each subcarrier pair of a plurality of subcarrier pairs.

Aspect 36: The apparatus of any of Aspects 29 to 35, wherein the one or more processors are configured to: select a respective step size for each subcarrier pair of the plurality of subcarrier pairs based on the respective step size included in the phase measurement request.

Aspect 37: The apparatus of any of Aspects 29 to 36, wherein the phase measurement report includes a measured phase difference between at least one subcarrier pair and an associated step size.

Aspect 38: The apparatus of any of Aspects 29 to 37, wherein the phase measurement capability includes a minimum phase measurement capability of the apparatus.

Aspect 39: The apparatus of any of Aspects 29 to 38, wherein the one or more processors are configured to: select a step size for at least one subcarrier pair.

Aspect 40: The apparatus of any of Aspects 29 to 39, wherein the step size is selected from a predefined number of step sizes.

Aspect 41: The apparatus of any of Aspects 29 to 40, wherein the step size is selected based on a quality of a measured phase difference between at least one subcarrier pair.

Aspect 42: The apparatus of any of Aspects 29 to 41, wherein the one or more processors are configured to: select different step sizes for measure phase differences between respective subcarrier pairs of different reference signal resources.

Aspect 43: The apparatus of any of Aspects 29 to 42, wherein the one or more processors are configured to: select different step sizes for measure phase differences between different subcarrier pairs based on a type of resource associated with the different subcarrier pairs.

Aspect 44: The apparatus of any of Aspects 29 to 43, wherein the phase measurement capability includes information associated with an ability of the apparatus to measure a phase difference between a maximum subcarrier pair.

Aspect 45: The apparatus of any of Aspects 29 to 44, wherein the information includes at least one of a wavelength associated with the maximum subcarrier pair, a frequency associated with the maximum subcarrier pair, or a subcarrier difference associated with the maximum subcarrier pair.

Aspect 46: The apparatus of any of Aspects 29 to 45, wherein the phase measurement capability includes information associated with a capability of the apparatus to measure a phase difference between a minimum subcarrier pair.

Aspect 47: The apparatus of any of Aspects 29 to 46, wherein the information includes at least one of a wavelength associated with the minimum subcarrier pair, a frequency associated with the minimum subcarrier pair, or a subcarrier difference associated with the minimum subcarrier pair.

Aspect 48: The apparatus of any of Aspects 29 to 47, wherein the phase measurement capability includes information associated with a capability of the apparatus to report measurements on a maximum number of subcarrier pairs.

Aspect 49: The apparatus of any of Aspects 29 to 48, wherein the phase measurement capability includes information associated with an ability of the apparatus to resolve minimum phase ambiguity.

Aspect 50: An apparatus for wireless communications, comprising: a memory; and one or more processors coupled to the memory, the one or more processors configured to: receive a phase measurement capability of a user equipment (UE) for determine a position of the UE; transmit, to the UE, a phase measurement request for report phase measurements for one or more subcarriers received by the UE, the phase measurement request be based on the phase measurement capability of the UE; and receive a phase measurement report based on the phase measurement request, the phase measurement report including information associated with a measured phase of at least one subcarrier of the one or more subcarriers.

Aspect 51: The apparatus of Aspect 50, wherein the phase measurement request includes a step size associated with a plurality of phase measurements for a plurality of subcarrier pairs.

Aspect 52: The apparatus of any of Aspects 50 to 51, wherein the phase measurement request includes a respective step size for each subcarrier pair of a plurality of subcarrier pairs.

Aspect 53: The apparatus of any of Aspects 50 to 52, wherein the phase measurement report includes a measured phase difference between at least one subcarrier pair and an associated step size.

Aspect 54: The apparatus of any of Aspects 50 to 53, wherein the phase measurement capability includes at least one of a minimum phase measurement capability of the UE.

Aspect 55: The apparatus of any of Aspects 50 to 54, wherein the phase measurement capability includes information associated with a capability of the UE to measure a phase difference between a maximum subcarrier pair.

Aspect 56: The apparatus of any of Aspects 50 to 55, wherein the phase measurement capability includes information associated with a capability of the UE to measure a phase difference between a minimum subcarrier pair.

Aspect 57: At least one non-transitory computer-readable medium containing instructions which, when executed by one or more processors, cause the one or more processors to perform a method according to any of Aspects 1 to 21.

Aspect 58: An apparatus comprising means for performing a method according to any of Aspects 1 to 21.

Aspect 59: At least one non-transitory computer-readable medium containing instructions which, when executed by one or more processors, cause the one or more processors to perform a method according to any of Aspects 22 to 28.

Aspect 60: An apparatus comprising means for performing a method according to any of Aspects 22 to 28.

1. A method for wireless communications at a user equipment (UE), comprising:
transmitting, at the UE, a phase measurement capability of the UE to a network entity for determining a position of the UE;
receiving, at the UE from the network entity, a phase measurement request for reporting phase measurements for one or more subcarriers received by the UE, the phase measurement request being based on the phase measurement capability of the UE; and
transmitting a phase measurement report to the network entity based on the phase measurement request, the phase measurement report including information associated with a measured phase of at least one subcarrier of the one or more subcarriers.

2. The method of claim 1, further comprising:
measuring, at the UE based on the phase measurement request, a phase of the at least one subcarrier of the one or more subcarriers.

3. The method of claim 1, wherein the phase measurement request includes a step size associated with a plurality of phase measurements for a plurality of subcarrier pairs.

4. The method of claim 3, further comprising:
selecting a respective step size from a plurality of step sizes for each subcarrier or subcarrier pair of the plurality of subcarriers or subcarrier pairs based at least on the phase measurement capability.

5. The method of claim 4, wherein the respective step size for each subcarrier pair is selected based on an overhead associated with measuring of a phase difference for each subcarrier pair.

6. The method of claim 3, further comprising: selecting a respective step size from a plurality of step sizes for each subcarrier or subcarrier pair of the plurality of subcarriers or subcarrier pairs based at least on the step size included in the phase measurement request.

7. The method of claim 1, wherein the phase measurement request includes a respective step size for each subcarrier pair of a plurality of subcarrier pairs.

8. The method of claim 7, further comprising:
selecting a respective step size for each subcarrier pair of the plurality of subcarrier pairs based on the respective step size included in the phase measurement request.

9. The method of claim 1, wherein the phase measurement report includes a measured phase difference between at least one subcarrier pair and an associated step size.

10. The method of claim 1, wherein the phase measurement capability includes a minimum phase measurement capability of the UE.

11. The method of claim 1, further comprising:
selecting, at the UE, a step size for at least one subcarrier pair.

12. The method of claim 11, wherein the step size is selected from a predefined number of step sizes.

13. The method of claim 11, wherein the step size is selected based on a quality of a measured phase difference between at least one subcarrier pair.

14. The method of claim 1, further comprising:
selecting, at the UE, different step sizes for measuring phase differences between respective subcarrier pairs of different reference signal resources.

15. The method of claim 1, further comprising:
selecting, at the UE, different step sizes for measuring phase differences between different subcarrier pairs based on a type of resource associated with the different subcarrier pairs.

16. The method of claim 1, wherein the phase measurement capability includes information associated with an ability of the UE to measure a phase difference between a maximum subcarrier pair.

17. The method of claim 16, wherein the information includes at least one of a wavelength associated with the maximum subcarrier pair, a frequency associated with the maximum subcarrier pair, or a subcarrier difference associated with the maximum subcarrier pair.

18. The method of claim 1, wherein the phase measurement capability includes information associated with a capability of the UE to measure a phase difference between a minimum subcarrier pair.

19. The method of claim 18, wherein the information includes at least one of a wavelength associated with the minimum subcarrier pair, a frequency associated with the minimum subcarrier pair, or a subcarrier difference associated with the minimum subcarrier pair.

20. The method of claim 1, wherein the phase measurement capability includes information associated with a capability of the UE to report measurements on a maximum number of subcarrier pairs.

21. The method of claim 1, wherein the phase measurement capability includes information associated with an ability of the UE to resolve minimum phase ambiguity.

22. A method for wireless communications at a network entity, comprising:
receiving, at the network entity, a phase measurement capability of a user equipment (UE) for determining a position of the UE;
transmitting, to the UE, a phase measurement request for reporting phase measurements for one or more subcarriers received by the UE, the phase measurement request being based on the phase measurement capability of the UE; and
receiving, at the network entity, a phase measurement report based on the phase measurement request, the phase measurement report including information associated with a measured phase of at least one subcarrier of the one or more subcarriers.

23. The method of claim 22, wherein the phase measurement request includes a step size associated with a plurality of phase measurements for a plurality of subcarrier pairs.

24. The method of claim 22, wherein the phase measurement request includes a respective step size for each subcarrier pair of a plurality of subcarrier pairs.

25. The method of claim 22, wherein the phase measurement report includes a measured phase difference between at least one subcarrier pair and an associated step size.

26. The method of claim 22, wherein the phase measurement capability includes at least one of a minimum phase measurement capability of the UE.

27. The method of claim 22, wherein the phase measurement capability includes information associated with a capability of the UE to measure a phase difference between a maximum subcarrier pair.

28. The method of claim 22, wherein the phase measurement capability includes information associated with a capability of the UE to measure a phase difference between a minimum subcarrier pair.

29. An apparatus for wireless communications, comprising:
a memory; and
one or more processors coupled to the memory, the one or more processors configured to:
transmit a phase measurement capability of the apparatus to a network entity for determining a position of the apparatus;
receive, from the network entity, a phase measurement request for report phase measurements for one or more subcarriers received by the apparatus, the phase measurement request be based on the phase measurement capability of the apparatus; and
transmit a phase measurement report to the network entity based on the phase measurement request, the phase measurement report including information associated with a measured phase of at least one subcarrier of the one or more subcarriers.

30. The apparatus of claim 29, wherein the one or more processors are configured to:
measure, based on the phase measurement request, a phase of the at least one subcarrier of the one or more subcarriers.

31. The apparatus of claim 29, wherein the phase measurement request includes a step size associated with a plurality of phase measurements for a plurality of subcarrier pairs.

32. The apparatus of claim 31, wherein the one or more processors are configured to:
select a respective step size from a plurality of step sizes for each subcarrier or subcarrier pair of the plurality of subcarriers or subcarrier pairs based at least on the phase measurement capability.

33. The apparatus of claim 32, wherein the respective step size for each subcarrier pair is selected based on an overhead associated with measuring of a phase difference for each subcarrier pair.

34. The apparatus of claim 31, wherein the one or more processors are configured to: selecting a respective step size from a plurality of step sizes for each subcarrier or subcarrier pair of the plurality of subcarriers or subcarrier pairs based at least on the step size included in the phase measurement request.

35. The apparatus of claim 29, wherein the phase measurement request includes a respective step size for each subcarrier pair of a plurality of subcarrier pairs.

36. The apparatus of claim 35, wherein the one or more processors are configured to:
select a respective step size for each subcarrier pair of the plurality of subcarrier pairs based on the respective step size included in the phase measurement request.

37. The apparatus of claim 29, wherein the phase measurement report includes a measured phase difference between at least one subcarrier pair and an associated step size.

38. The apparatus of claim 29, wherein the phase measurement capability includes a minimum phase measurement capability of the apparatus.

39. The apparatus of claim 29, wherein the one or more processors are configured to:
select a step size for at least one subcarrier pair.

40. The apparatus of claim 39, wherein the step size is selected from a predefined number of step sizes.

41. The apparatus of claim 39, wherein the step size is selected based on a quality of a measured phase difference between at least one subcarrier pair.

42. The apparatus of claim 29, wherein the one or more processors are configured to:
select different step sizes for measure phase differences between respective subcarrier pairs of different reference signal resources.

43. The apparatus of claim 29, wherein the one or more processors are configured to:
select different step sizes for measure phase differences between different subcarrier pairs based on a type of resource associated with the different subcarrier pairs.

44. The apparatus of claim 29, wherein the phase measurement capability includes information associated with an ability of the apparatus to measure a phase difference between a maximum subcarrier pair.

45. The apparatus of claim 44, wherein the information includes at least one of a wavelength associated with the maximum subcarrier pair, a frequency associated with the maximum subcarrier pair, or a subcarrier difference associated with the maximum subcarrier pair.

46. The apparatus of claim 29, wherein the phase measurement capability includes information associated with a capability of the apparatus to measure a phase difference between a minimum subcarrier pair.

47. The apparatus of claim 46, wherein the information includes at least one of a wavelength associated with the minimum subcarrier pair, a frequency associated with the minimum subcarrier pair, or a subcarrier difference associated with the minimum subcarrier pair.

48. The apparatus of claim 29, wherein the phase measurement capability includes information associated with a capability of the apparatus to report measurements on a maximum number of subcarrier pairs.

49. The apparatus of claim 29, wherein the phase measurement capability includes information associated with an ability of the apparatus to resolve minimum phase ambiguity.

50. An apparatus for wireless communications, comprising:
a memory; and
one or more processors coupled to the memory, the one or more processors configured to:
receive a phase measurement capability of a user equipment (UE) for determine a position of the UE;
transmit, to the UE, a phase measurement request for report phase measurements for one or more subcarriers received by the UE, the phase measurement request be based on the phase measurement capability of the UE; and
receive a phase measurement report based on the phase measurement request, the phase measurement report including information associated with a measured phase of at least one subcarrier of the one or more subcarriers.

51. The apparatus of claim 50, wherein the phase measurement request includes a step size associated with a plurality of phase measurements for a plurality of subcarrier pairs.

52. The apparatus of claim 50, wherein the phase measurement request includes a respective step size for each subcarrier pair of a plurality of subcarrier pairs.

53. The apparatus of claim 50, wherein the phase measurement report includes a measured phase difference between at least one subcarrier pair and an associated step size.

54. The apparatus of claim 50, wherein the phase measurement capability includes at least one of a minimum phase measurement capability of the UE.

55. The apparatus of claim 50, wherein the phase measurement capability includes information associated with a capability of the UE to measure a phase difference between a maximum subcarrier pair.

56. The apparatus of claim 50, wherein the phase measurement capability includes information associated with a capability of the UE to measure a phase difference between a minimum subcarrier pair.
